(19) United States
(12) Patent Application Publication
(10) Pub. No.: US 2017/0265130 A1
(43) Pub. Date: Sep. 14, 2017

(54) DYNAMIC BROADCAST TIME TO WAKE SERVICE PERIOD ALLOCATION

(71) Applicant: QUALCOMM Incorporated, San Diego, CA (US)

(72) Inventor: Naveen Kumar Kakani, Coppell, TX (US)

(21) Appl. No.: 15/450,802

(22) Filed: Mar. 6, 2017

Related U.S. Application Data
(60) Provisional application No. 62/306,008, filed on Mar. 9, 2016.

(51) Int. Cl. H04W 52/02; H04W 72/04; H04W 48/10

(52) U.S. Cl. CPC H04W 52/0206; H04W 48/10; H04W 72/0446; H04W 88/08

(57) ABSTRACT

Methods, systems, and devices for wireless communication are described. An access point (AP) may use a combination of broadcast, multicast, and unicast target wake time (TWT) procedures to coordinate communications with multiple stations (STAs) within a basic service set (BSS) based, for example, on the presence of data for particular STAs. Following a beacon frame broadcast, the AP may indicate TWT service periods (SPs) for communication with a subset of the STAs within a BSS, where the signal may include a trigger for the subset of STAs. The AP may also identify a presence of data for an STA during one TWT SP, and the AP may trigger the STA to operate during a subsequent TWT SP based on identifying the presence of data for the STA.

### CROSS REFERENCES

The present application for patent claims priority to U.S. Provisional Patent Application No. 62/306,008 by Kakani, et al., entitled “Dynamic Broadcast Time to Wake Service Period Allocation,” filed Mar. 9, 2016, assigned to the assignee hereof, and is hereby expressly incorporated by reference herein in its entirety.

### BACKGROUND

The following relates generally to wireless communication and more specifically to dynamic broadcast time to wake service period allocation.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., IEEE 802.11) network may include access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, an STA may communicate with an associated AP via downlink (DL) and uplink (UL). The DL (or forward link) may refer to the communication link from the AP to the STA, and the UL (or reverse link) may refer to the communication link from the STA to the AP.

In some cases, an AP communicating with a number of STAs may use techniques that enable power saving for the wireless devices in the WLAN. These techniques may include scheduling periods of communication and sleep for the STAs that the AP serves. In high density wireless environments, however, such as in the presence of a large number of STAs or an overlapping basic service set (OBSS), power saving techniques that rely on certain sleep cycle scheduling may be limited.

### SUMMARY

An access point (AP) may use a combination of broadcast, multicast, or unicast target wake time (TWT) procedures to communicate with multiple stations (STAs) within a basic service set (BSS). For example, an AP may broadcast a beacon frame to STAs of the BSS. The AP may then transmit signals (e.g., multicast signals) that indicate TWT service periods (SPs) for a subset of the STAs of the BSS. The AP may additionally or alternatively identify a presence of uplink or downlink data for an STA within the subset of STAs. The AP may then transmit another signal (e.g., broadcast, multicast, or unicast) that indicates a subsequent TWT SP for the STA with the identified data. The AP and subset of STAs may then communicate during the subsequent TWT SP. The AP may thus dynamically indicate TWT SPs to various STAs of a BSS based on the availability of uplink or downlink data for individual STAs. This dynamic scheme may allow the STAs to use the wireless medium of the BSS more efficiently than sleep cycle timing that does not account for specific needs of the STAs.

A method of wireless communication is described. The method may include transmitting a first signal that indicates a first TWT SP for a subset of STAs of a BSS that includes an AP, identifying, during the first TWT SP, a presence of uplink or downlink data for an STA of the subset of STAs and transmitting a second signal that indicates a second TWT SP for the STA based at least in part on identifying the presence of uplink or downlink data during the first TWT SP.

An apparatus for wireless communication is described. The apparatus may include means for transmitting a first signal that indicates a first TWT SP for a subset of STAs of a BSS that includes an AP, means for identifying, during the first TWT SP, a presence of uplink or downlink data for an STA of the subset of STAs and means for transmitting a second signal that indicates a second TWT SP for the STA based at least in part on identifying the presence of uplink or downlink data during the first TWT SP.

A further apparatus is described. The apparatus may include a processor, memory in electronic communication with the processor, and instructions stored in the memory. The instructions may be operable to cause the processor to transmit a first signal that indicates a first TWT SP for a subset of STAs of a BSS that includes an AP, identify, during the first TWT SP, a presence of uplink or downlink data for an STA of the subset of STAs and transmit a second signal that indicates a second TWT SP for the STA based at least in part on identifying the presence of uplink or downlink data during the first TWT SP.

A non-transitory computer readable medium for wireless communication is described. The non-transitory computer-readable medium may include instructions to cause a processor to transmit a first signal that indicates a first TWT SP for a subset of STAs of a BSS that includes an AP, identify, during the first TWT SP, a presence of uplink or downlink data for an STA of the subset of STAs and transmit a second signal that indicates a second TWT SP for the STA based on identifying the presence of uplink or downlink data during the first TWT SP.

Some examples of the method, apparatus, or non-transitory computer-readable medium described above may further include processes, features, means, or instructions for broadcasting a beacon frame that identifies a timing for the first TWT SP or an additional TWT SP for the BSS, where the first signal comprises a trigger frame for the subset of STAs.

In some examples of the method, apparatus, or non-transitory computer-readable medium described above, a beacon period initiated by the beacon frame comprises the first TWT SP and the second TWT SP. In some examples of the method, apparatus, or non-transitory computer-readable medium described above, a beacon period initiated by the beacon frame comprises the first TWT SP, and where a subsequent beacon period comprises the second TWT SP. In some examples of the method, apparatus, or non-transitory computer-readable medium described above, the beacon frame indicates a timing of the first signal.

Some examples of the method, apparatus, or non-transitory computer-readable medium described above may further include processes, features, means, or instructions for receiving a message from the STA during the first TWT SP, where the presence of uplink data for the STA is identified based on the received message. Some examples of the method, apparatus, or non-transitory computer-readable medium described above may further include processes, features, means, or instructions for determining a power saving mode of the STA, where the second signal is transmitted to the STA based on the determination of the power saving mode of the STA.

In some examples of the method, apparatus, or non-transitory computer-readable medium described above, the first signal comprises a first broadcast message transmitted to the subset of STAs and the second signal comprises a second broadcast message transmitted to the STA and one or more additional STAs of the subset. In some examples of the method, apparatus, or non-transitory computer-readable medium described above, the first signal comprises a broadcast message transmitted to the subset of STAs and the second signal comprises a unicast message transmitted to the STA.

Some examples of the method, apparatus, or non-transitory computer-readable medium described above may further include processes, features, means, or instructions for transmitting a first downlink message to the STA during the first TWT SP. Some examples of the method, apparatus, or non-transitory computer-readable medium described above may further include processes, features, means, or instructions for transmitting a second downlink message to the STA during the second TWT SP, where the second downlink message transmission is based on the identified presence of downlink data during the first TWT SP.

Some examples of the method, apparatus, or non-transitory computer-readable medium described above may further include processes, features, means, or instructions for communicating with another subset of STAs of the BSS during a third TWT SP, where the other subset of STAs excludes STAs triggered for the first TWT SP. In some examples of the method, apparatus, or non-transitory computer-readable medium described above, the second TWT SP occurs before the third TWT SP. In some examples of the method, apparatus, or non-transitory computer-readable medium described above, the second TWT SP occurs after the third TWT SP.

Some examples of the method, apparatus, or non-transitory computer-readable medium described above may further include processes, features, means, or instructions for identifying, during the third TWT SP, a presence of uplink or downlink data for an STA of the other subset of STAs. Some examples of the method, apparatus, or non-transitory computer-readable medium described above may further include processes, features, means, or instructions for transmitting a third signal that indicates the second TWT SP for the STA of the other subset of STAs. Some examples of the method, apparatus, or non-transitory computer-readable medium described above may further include processes, features, means, or instructions for communicating with the STA of the other subset of STAs during the second TWT SP.

Some examples of the method, apparatus, or non-transitory computer-readable medium described above may further include processes, features, means, or instructions for communicating with another subset of STAs of the BSS during a third TWT SP, where the other subset of STAs includes STAs triggered for the first TWT SP. Some examples of the method, apparatus, or non-transitory computer-readable medium described above may further include processes, features, means, or instructions for communicating with the STA and another subset of STAs of the BSS during the second TWT SP.

In some examples of the method, apparatus, or non-transitory computer-readable medium described above, the second TWT SP comprises a next TWT SP following the first TWT SP. Some examples of the method, apparatus, or non-transitory computer-readable medium described above may further include processes, features, means, or instructions for receiving a message from the STA that indicates a buffer status of the STA. Some examples of the method, apparatus, or non-transitory computer-readable medium described above may further include processes, features, means, or instructions for receiving uplink data from the STA based on receiving the buffer status.

Some examples of the method, apparatus, or non-transitory computer-readable medium described above may further include processes, features, means, or instructions for receiving uplink data from the STA during an interval between the first TWT SP and the second TWT SP. Some examples of the method, apparatus, or non-transitory computer-readable medium described above may further include processes, features, means, or instructions for determining an operating mode of the STA, where the first signal or the second signal is transmitted based on the determination of the operating mode.

Some examples of the method, apparatus, or non-transitory computer-readable medium described above may further include processes, features, means, or instructions for receiving a message from the STA that indicates a requested termination time for the first TWT SP. Some examples of the method, apparatus, or non-transitory computer-readable medium described above may further include processes, features, means, or instructions for determining to transmit a second message based on the received message.

A method of wireless communication is described. The method may include receiving from an access point (AP) a first signal that indicates a first TWT SP, communicating with the AP during the first TWT SP and receiving, during the first TWT SP, a second signal that indicates a second TWT SP for communicating with the AP.

An apparatus for wireless communication is described. The apparatus may include means for receiving from an access point (AP) a first signal that indicates a first TWT SP, means for communicating with the AP during the first TWT SP and means for receiving, during the first TWT SP, a second signal that indicates a second TWT SP for communicating with the AP.

A further apparatus is described. The apparatus may include a processor, memory in electronic communication with the processor, and instructions stored in the memory. The instructions may be operable to cause the processor to receive from an access point (AP) a first signal that indicates a first TWT SP, communicate with the AP during the first TWT SP and receive, during the first TWT SP, a second signal that indicates a second TWT SP for communicating with the AP.

A non-transitory computer readable medium for wireless communication is described. The non-transitory computer-readable medium may include instructions to cause a processor to receive from an access point (AP) a first signal that indicates a first TWT SP, communicate with the AP during the first TWT SP and receive, during the first TWT SP, a second signal that indicates a second TWT SP for communicating with the AP.

Some examples of the method, apparatus, or non-transitory computer-readable medium described above may further include processes, features, means, or instructions for receiving a beacon frame that identifies a timing for the first TWT SP or an additional TWT SP for a BSS, where the first signal comprises a trigger frame for a subset of STAs of the BSS.

In some examples of the method, apparatus, or non-transitory computer-readable medium described above, a beacon period initiated by the beacon frame comprises the first TWT SP and the second TWT SP. In some examples of the method, apparatus, or non-transitory computer-readable medium described above, a beacon period initiated by the beacon frame comprises the first TWT SP, and where a subsequent beacon period comprises the second TWT SP.

In some examples of the method, apparatus, or non-transitory computer-readable medium described above, the beacon frame indicates a timing of the first signal. Some examples of the method, apparatus, or non-transitory computer-readable medium described above may further include processes, features, means, or instructions for transmitting a message during the first TWT SP, where the message indicates a presence of uplink data.

Some examples of the method, apparatus, or non-transitory computer-readable medium described above may further include processes, features, means, or instructions for transmitting a message to the AP that indicates a power saving mode, where the second signal is transmitted based on the power saving mode of the STA. In some examples of the method, apparatus, or non-transitory computer-readable medium described above, the first signal comprises a broadcast message transmitted to the subset of STAs and the second signal comprises a unicast message transmitted to the STA.

Some examples of the method, apparatus, or non-transitory computer-readable medium described above may further include processes, features, means, or instructions for receiving a first downlink message during the first TWT SP. Some examples of the method, apparatus, or non-transitory computer-readable medium described above may further include processes, features, means, or instructions for receiving a second downlink message during the second TWT SP, where the second downlink message transmission comprises data buffered at the AP during the first TWT SP.

Some examples of the method, apparatus, or non-transitory computer-readable medium described above may further include processes, features, means, or instructions for transmitting a message that indicates a buffer status. Some examples of the method, apparatus, or non-transitory computer-readable medium described above may further include processes, features, means, or instructions for transmitting uplink data during the first TWT SP or the second TWT SP based on transmitted the buffer status.

Some examples of the method, apparatus, or non-transitory computer-readable medium described above may further include processes, features, means, or instructions for transmitting uplink data from the STA during an interval between the first TWT SP and the second TWT SP. Some examples of the method, apparatus, or non-transitory computer-readable medium described above may further include processes, features, means, or instructions for transmitting a message to the AP that indicates an operating mode, where the first signal or the second signal is transmitted based on the indication of the operating mode.

Some examples of the method, apparatus, or non-transitory computer-readable medium described above may further include processes, features, means, or instructions for transmitting a message that indicates a requested termination time for the first TWT SP, where the second message is transmitted based on the message.

### BRIEF DESCRIPTION OF THE DRAWINGS

FIG. 1 illustrates an example of a wireless communications system that supports dynamic broadcast time to wake service period allocation in accordance with various aspects of the present disclosure;

FIG. 2 illustrates an example of a wireless communications system that supports dynamic broadcast time to wake service period allocation in accordance with various aspects of the present disclosure;

FIG. 3 illustrates an example of a TWT SP configuration in a system that supports dynamic broadcast time to wake service period allocation in accordance with various aspects of the present disclosure;

FIG. 4 illustrates an example of a process flow in a system that supports dynamic broadcast time to wake service period allocation in accordance with various aspects of the present disclosure;

FIGS. 5 through 7 show block diagrams of a wireless device or devices that supports dynamic broadcast time to wake service period allocation in accordance with various aspects of the present disclosure;

FIG. 8 illustrates a block diagram of a system including an AP that supports dynamic broadcast time to wake service period allocation in accordance with various aspects of the present disclosure;

FIGS. 9 through 11 show block diagrams of a wireless device or devices that supports dynamic broadcast time to wake service period allocation in accordance with various aspects of the present disclosure;

FIG. 12 illustrates a block diagram of a system including an STA that supports dynamic broadcast time to wake service period allocation in accordance with various aspects of the present disclosure; and

FIGS. 13 through 18 illustrate methods for dynamic broadcast time to wake service period allocation in accordance with various aspects of the present disclosure.

### DETAILED DESCRIPTION

In some wireless communications systems, an access point (AP) may use target wake time (TWT) procedures to schedule communications for multiple stations (STAs). The TWT procedures may enable increased power savings and efficiency in a basic service set (BSS) that includes the AP by enabling scheduled periods of sleep and communication. That is, a TWT procedure may enable the AP to indicate to specific STAs whether they should power up to communicate during a TWT service period (SP). The indicated STAs may include all or a subset of STAs of a BSS that includes the AP.

TWT procedures may be used in various ways, and may include solicited TWT and broadcast TWT. With solicited TWT, an STA may request that the AP schedule a TWT SP for the STA to communicate. The STA's request may be based on various network conditions, such as an uplink (UL) traffic pattern or the capabilities of a network to provide service (e.g., quality of Service (QoS)). In some cases, an AP may schedule a group of STAs to the same solicited TWT SP, where the group of STAs are fixed. Broadcast TWT may be scheduled by the AP regardless of TWT requests received from STAs, and a beacon frame may be used to signal the presence a TWT SP to one or more STAs. Using a trigger frame, the AP may verify if the STA is awake, and if not, the STA may wake up at a subsequent trigger frame at a next TWT SP and communicate with the AP. Certain wireless environments that include a relatively high number of wireless devices (e.g., dense wireless environments) may result in the loss of scheduled TWT allocations. In these cases, a large number of STAs attempting to access a single AP may impact the efficiency of TWT procedures.

In some cases, and as described herein, broadcast TWT may be used to dynamically schedule STAs for efficient communication in dense wireless environments. For example, an AP may broadcast a beacon frame to STAs of the BSS. The AP may then transmit signals (e.g., multicast signals) that indicate TWT SPs for a subset of the STAs of the BSS. The AP may additionally or alternatively identify a presence of uplink resource allocation or downlink data, or both, for an STA within the subset of STAs. The AP may then transmit another signal (e.g., broadcast, multicast, or unicast) that indicates a subsequent TWT SP for the STA with the identified data. The AP and subset of STAs may then communicate during the subsequent TWT SP.

By way of example, an AP may broadcast or multicast a trigger frame to identify the presence and amount of data an STA may have, where the transmission time of the trigger frame may be signaled in a preceding beacon frame, and one or more trigger frames may be scheduled during a given beacon period. The AP may then coordinate access to the wireless medium of the BSS based on the presence of uplink or downlink data for various STAs of the BSS. For example, STAs in a power saving mode that are indicated as having data at the AP by the beacon frame may subsequently send a response that includes a buffer status. The buffer status may include a type of data or traffic the STA is ready to send, may include an indication of the amount of data to send, and may include an indication that the STA is awake.

Following receipt of the response from the one or more STAs, the AP may be aware of the buffer status for at least a subset of the STAs of a BSS (e.g., the STAs who were included in the trigger frame). In some cases, the AP may not be able to schedule UL resource units (RUs), such as when the AP does not have enough time to process the signaling received from the STA(s). However, the AP may continue with sending the DL transmission during the same TWT SP. After the DL transmission, resource allocation for UL transmissions may continue. If there is enough time remaining in the TWT SP, and the data exchange is complete, the one or more STAs may subsequently go to sleep. But if there are STAs that have additional data (either DL or UL), the AP may signal a next TWT SP for these STAs to communicate and the STAs may sleep until that time.

Thus, the AP may identify those STAs of the BSS with queued data during a TWT SP, and the AP may indicate a subsequent TWT SP to those STAs based on the presence of the data. In this way, the AP may coordinate access to the wireless medium based on the needs of particular STAs, rather than directing STAs to wake and sleep without reference to a presence of data. This may help avoid congestion issues for high-density BSSs, for OBSSs, and may avoid the underutilization of resources (e.g., a solicited TWT SP may be allocated for a fixed group of STAs that may not have data to communicate during the TWT SP).

Aspects of the disclosure are introduced above are described below in the context of a wireless communication system. An example of broadcast TWT SP configuration is then described for wireless devices using dynamic broadcast time to wake service period allocation. Aspects of the disclosure are further illustrated by and described with reference to apparatus diagrams, system diagrams, and flowcharts that relate to dynamic broadcast time to wake service period allocation.

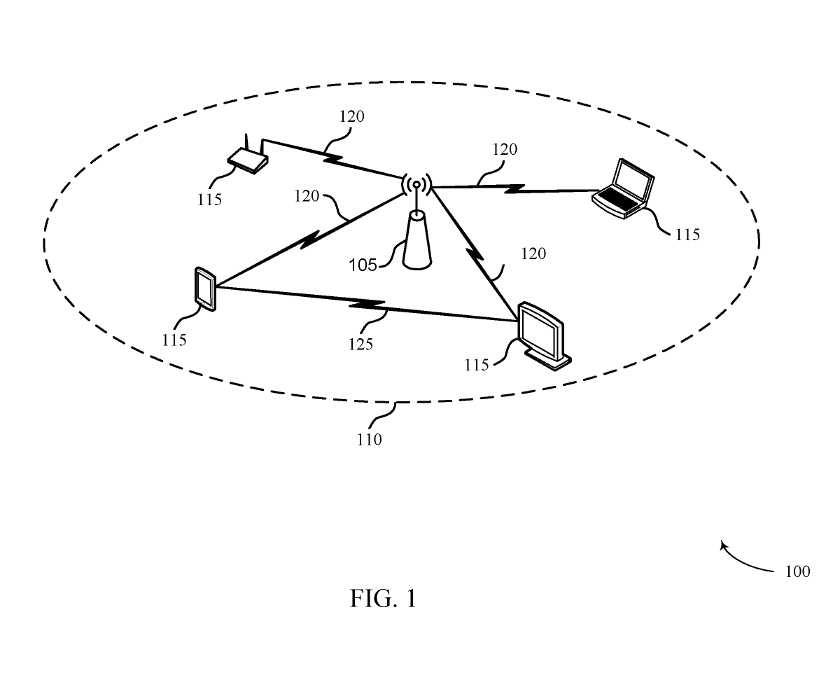

FIG. 1 illustrates a wireless local area network (WLAN) 100 (which may be a Wi-Fi network) configured in accordance with various aspects of the present disclosure. The WLAN 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated STAs 115 may represent a BSS or an extended service set (ESS). The various STAs 115 in the network are able to communicate with one another through the AP 105. Also shown is a coverage area 110 of the AP 105, which may represent a basic service area (BSA) of the WLAN 100. An extended network station (not shown) associated with the WLAN 100 may be coupled with a wired or wireless distribution system that may allow multiple APs 105 to be connected in an ESS. WLAN 100 may represent a network that supports dynamic TWT SPs.

Although not shown in FIG. 1, an STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two STAs 115 may additionally or alternatively communicate directly via a direct wireless link 125 regardless of whether both STAs 115 are in the same coverage area 110. In some cases, a second BSS may be present within a relatively close proximity of coverage area 110. The second BSS may be referred to as an overlapping basic service set (OBSS). In some cases, an OBSS may be a source of interference to one or more STAs 115, where additional wireless devices associated with the OBSS may be referred to as hidden nodes and affect communications and throughput for the STAs 115.

Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and medium access control (MAC) layers from IEEE 802.11 and versions including, but not limited to, 802.11b, 802.11g, 802.11a, 802.11n, 802.11ac, 802.11ad, 802.11ah, etc. In other implementations, peer-to-peer connections or ad hoc networks may be implemented within WLAN 100.

In some cases, an STA 115 or AP 105 may operate in a shared or unlicensed frequency spectrum. This frequency spectrum may result in the STA 115 or AP 105 contending for access to the wireless medium. Thus, these devices may perform a clear channel assessment (CCA) prior to communicating in order to determine whether the channel is available. A CCA may include an energy detection procedure to determine whether there are any other active transmissions. For example, the device may infer that a change in a received signal strength indicator (RSSI) of a power meter indicates that a channel is occupied. Specifically, signal power is that is concentrated in a certain bandwidth and exceeds a predetermined noise floor may indicate another wireless transmitter. A CCA may also include detection of specific sequences that indicate use of the channel. For example, another device may transmit a specific preamble prior to transmitting a data sequence.

An AP 105 may schedule communication and sleep periods for the STAs 115 that it serves using TWT procedures. The TWT procedures may enable increased power savings by enabling the AP 105 to indicate to specific STAs 115 within a BSS whether they should power up to communicate during a TWT SP. The TWT procedures may be used in two different ways: solicited TWT or broadcast TWT. With solicited TWT, an STA 115 may request that the AP 105 schedule a TWT SP for the STA 115 to communicate. The request from the STA 115 may be based on various circumstances, such as an UL traffic pattern or the capabilities of a network to provide service (e.g., QoS). The requested TWT SP may be used irrespective of bit settings (e.g., traffic indication map (TIM) bit settings) within a beacon frame. In some cases, an AP 105 may allocate the same solicited TWT SP to one or more STAs 115 (such as a fixed set of STAs 115), but at the beginning of the TWT SP the AP 105 may determine the amount of data at the STAs 115 and allocate the resources for the TWT SP.

Broadcast TWT may be scheduled by the AP 105 regardless of any TWT request received from an STA 115. In such cases, a TIM bit in a beacon frame may be used to signal the presence of data to one or more STAs 115 that are in power save mode, where the TIM bit may include an STA identification (ID). For example, a TIM bit may be set to 0 when no data is available or set to 1 when there is data to be sent. An STA 115 may then identify the TIM bit setting within a received beacon frame. Additionally or alternatively, a broadcast TWT SP can be used for data exchange with STAs 115 that are not in power save mode, and a TIM bit may not be used for signaling.

An AP 105 may verify if the STA 115 is awake using a trigger frame, and if not, the STA 115 may wake up at a subsequent trigger frame and communicate with the AP 105. In some cases, the AP 105 may signal the next beacon frame of the broadcast TWT, which may include a target beacon transmission time (TBTT) or a timing synchronization function (TSF) time, that indicates when the next allocation for the one or more STAs 115 will occur. A TWT element in the beacon frame may additionally or alternatively signal a periodicity or a next broadcast TWT period. In some examples, an STA 115 may transmit a TWT request frame to the AP 105 that identifies the TBTT of the next beacon frame and the interval between subsequent beacon frames the STA 115 intends to receive.

Certain wireless environments that include a relatively high number of wireless devices (e.g., dense wireless environments) may result in the loss of solicited TWT allocations. Dense wireless environments may include residential locations (e.g., an apartment complex) or public hot spots (e.g., within a shopping mall, etc.) that may have multiple wireless devices in close proximity. In these cases, OBSSs or a large number of STAs 115 attempting to access a single AP 105 may impact the efficiency of TWT procedures. For example, when multiple STAs 115 have data to transmit and simultaneously attempt to compete for the medium, the increased number of STAs 115 may result in the loss of scheduled TWT allocation as the AP 105 determines which STAs 115 have data to transmit.

By way of example, the relative efficiency of solicited TWT and broadcast TWT in dense environments may be considered or evaluated by reference to various parameters corresponding to probabilities associated with TWT procedures. For example, a parameter PR_{dense} may represent the probability of loss of an allocated SP (related to solicited TWT allocation). In some cases, PR_{dense} may impact power consumption for solicited TWT, but there may not be any throughput loss as the medium is still used. A parameter PR_{under} may represent the probability that an allocated SP is not sufficient to service the STA 115 for both UL and DL transmission (where the STA 115 may complete the remaining data exchange through other methods, such as enhanced distributed channel access (EDCA)), which may result in a drop in QoS. A parameter PRₒᵥₑᵣ may represent the probability that the SP is an over-allocation that results in a wastage of system resources and PRₒᵥₑᵣ may impact system throughput loss. Additionally, a parameter PRₒₚₜᵢₘₐₗ may represent the probability that the SP is an efficient allocation.

The power consumption of solicited TWT may be analyzed using the equation:

P₂*PR_{dense}+(1−PR_{dense})*(P1*PRₒₚₜᵢₘₐₗ+P3*PR_{under}+P4*PRₒᵥₑᵣ) (1)

where P1 is the power consumption when resources are allocated optimally, P2 is the power consumption when there is a loss of a solicited TWT slot due to a dense wireless environment, P3 is the power consumption when resources are under-allocated, and P4 is the power consumption when resources are over-allocated. In some cases, the power consumption associated with parameters P2 and P3 may increase due to the medium being occupied due to an increase in density of the wireless environment (e.g., the presence of an OBSS or a large number of STAs 115, as discussed above). Broadcast TWT may be similarly analyzed using a parameter P5, where P5 is the power consumption associated with broadcast TWT.

Additionally, system capacity loss may be defined as the period of time that is allocated and not used along with the signaling overhead. For example, broadcast TWT may result in a loss of system capacity because the transmission of a trigger frame plus a corresponding frame transmitted by an STA 115 (such as a power save poll (PS-Poll) frame, a QoS null frame, etc.) may last a certain duration during every beacon frame (e.g., approximately 1-2 ms every beacon frame, or 1-2% of the beacon frame). In some cases, solicited TWT may experience a loss in system capacity when the resources are over-allocated (e.g., according to a percentage), which may be represented by the equation:

$$( 1 - {PR}_{dense} ) * {PR}_{over} * \frac{Amount of Over \text{-} Allocation}{{SP}_{Allocation}} \\ where \frac{Amount of Over \text{-} Allocation}{{SP}_{Allocation}} = 1 \text{:} 2. \qquad ( 2 )$$

Using the above referenced parameters and Equations 1 and 2, Table 1 provides an example of results associated with the analysis of power and throughput loss under multiple PR_{dense} conditions, and Table 2 provides an example of results associated with the analysis of power and throughput loss under different PRₒᵥₑᵣ conditions.

TABLE 1

| | |
|---|---|
| Power (Relative) | Throughput Loss (%) |

| PR_{dense} | Solicited | Broadcast | Solicited | Broadcast |
|---|---|---|---|---|
| 0.2 | 1.2 | 1.5 | 10 | 2 |
| 0.4 | 1.275 | 1.5 | 7.5 | 2 |
| 0.5 | 1.31 | 1.5 | 6.25 | 2 |
| 0.6 | 1.35 | 1.5 | 5 | 2 |
| 0.7 | 1.39 | 1.5 | 3.75 | 2 |

TABLE 2

| | |
|---|---|
| Power (Relative) | Throughput Loss (%) |

| PRₒᵥₑᵣ | Solicited | Broadcast | Solicited | Broadcast |
|---|---|---|---|---|
| 0.1 | 1.35 | 1.5 | 2.5 | 2 |
| 0.2 | 1.32 | 1.5 | 5 | 2 |
| 0.3 | 1.6 | 1.5 | 7.5 | 2 |
| 0.4 | 1.27 | 1.5 | 10 | 2 |
| 0.5 | 1.25 | 1.5 | 12.5 | 2 |

Based on results represented in Table 1 and Table 2, scheduled access provided by solicited TWT may provide improvements with power savings. But a fixed schedule for STAs 115 may limit medium utilization and, if the traffic is bursty, an STA 115 may have to wake up outside the SP to send data over the medium. Thus, the amount of power savings that can be provided to the STA 115 using solicited TWT may be limited. A broadcast TWT mechanism may similarly allow for power saving and may additionally or alternatively be used to adapt to bursty traffic for STAs 115. That is, broadcast TWT may allocate the medium according to the wireless traffic during the beacon period. Thus, when operating in unlicensed spectrum, a dynamic broadcast TWT as described herein may enable greater efficiency and power savings for communications in dense wireless environments.

As described herein, an AP 105 may use TWT procedures to communicate with multiple STAs 115 within a BSS. Following a beacon frame broadcast, the AP 105 may transmit signals that indicate TWT SPs used for communication with a subset of the multiple STAs 115. For example, the signal may include a trigger for the subset of STAs 115. The AP 105 may also identify a presence of uplink or downlink data for an STA 115 within a given subset, where the identification of UL data may be based on a message received from an STA 115. The AP 105 and the subset of STAs 115 may communicate during the TWT SP, and in some cases, the AP 105 may transmit another signal that indicates a next TWT SP based on the presence of the data. The AP 105 and subset of STAs 115 may then communicate during the next TWT SP.

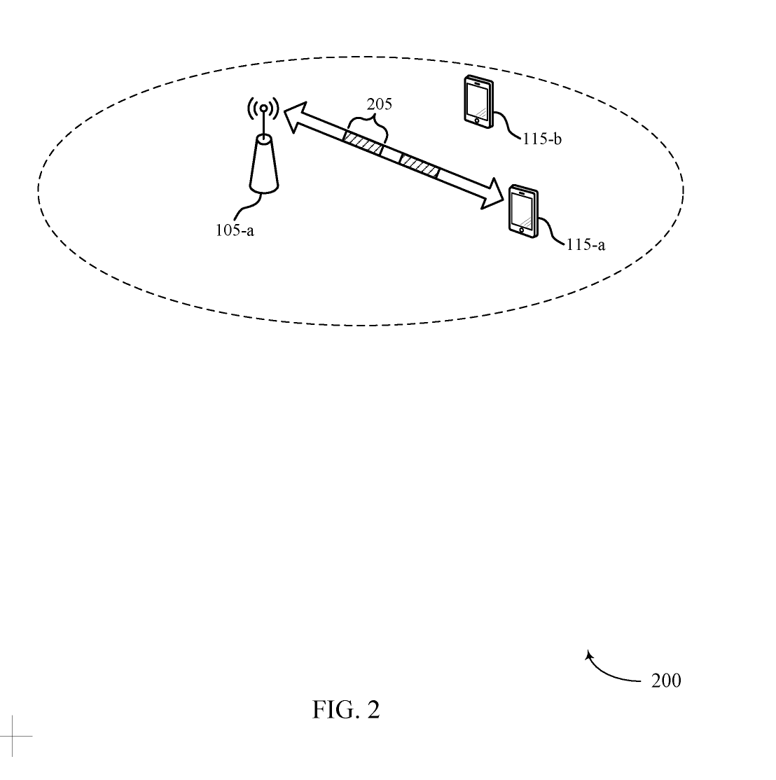

FIG. 2 illustrates an example of a wireless communications system 200 for dynamic broadcast time to wake service period allocation in accordance with various aspects of the present disclosure. Wireless communications system 200 may be an example of a WLAN, and may include AP 105-a and STA 115-a, which may be examples of the corresponding devices described with reference to FIG. 1. Wireless communications system 200 may represent a system that supports enhanced power saving techniques using dynamic TWT SPs for subsets of STAs 115.

In wireless communications system 200, AP 105-a may use broadcast TWT to dynamically schedule one or more STAs 115 (e.g., STA 115-a and STA 115-b) for efficient communication and power savings. That is, TWT procedures may enable AP 105-a to indicate to specific STAs 115 in a BSS whether they should power up to communicate during a TWT SP 205. For example, AP 105-a may broadcast a trigger frame, where the transmission time of the trigger frame is signaled in a preceding beacon frame and one or more trigger frames may be scheduled during a given beacon period. STA 115-a may be in a power save mode and may be indicated by the beacon frame. STA 115-a may subsequently send a response that includes a buffer status. The buffer status may include an indication of the type of data or traffic STA 115-a is ready to send, an indication of the amount of data to send, and an indication that the STA 115-a is awake. In one example, STA 115-a may respond by sending a QoS null frame.

Following receipt of the response from STA 115-a, AP 105-a may be aware of the buffer status for STAs 115-a, but AP 105-a may not be able to schedule UL RUs. For example, AP 105-a may not have enough time to process the signaling received from STA 115-a. However, AP 105-a may continue with sending DL transmissions during the same TWT SP 205. As a result, this communication may tend towards short inter-frame space (SIFS) bursts.

After the DL data transmission, which may be sent using orthogonal frequency multiple access (OFDMA)/multiple user (MU) communications, the SIFS burst may continue to allow allocation of UL RUs for UL transmissions. If there is enough time in TWT SP 205 remaining, and data exchange is complete, STA 115-a may subsequently go to sleep. In some cases, STA 115-a may have additional data queued (either DL or UL), and AP 105-a may signal STA 115-a to use the next TWT SP 205 to communicate, and STA 115-a may sleep (e.g., power down aspects of its radio frequency (RF) chain) until that time.

In some cases, a power management (PM) bit for the STAs 115 may be zero, and the STAs 115 may be expected to be awake for a next TWT SP. For example, AP 105-a may signal whether transmissions of DL data to STA 115-a may wait until a next TWT SP 205. AP 105-a may include the signaling for the next TWT SP 205 via a unicast or multicast transmission to all (or a subset) of the STAs 115. Additionally or alternatively, AP 105-a may transmit the signaling using a single message, which may indicate that all STAs 115 that have received all of the data currently scheduled (e.g., by setting a more data bit equal to 1) and have not signaled that they do not have any UL data may implicitly be awake at the signaled TWT SP 205 (e.g., using a TWT information element (IE)). In some cases, there may be no restriction on STAs 115 to transmit on UL.

The STAs 115 that are not included in the trigger frame sent by AP 105-a may continue to sleep until the next TWT SP 205 (as announced in the beacon frame). This may be signaled in the first trigger frame sent by AP 105-a, or can be included in the TWT IE of a trigger frame to announce whether STAs 115-a, which may not be included in the first trigger frame, will be serviced during the TWT SP 205 or not. In some cases, it may not be possible for AP 105-a to extend the TWT SP 205 or any remaining period in the TWT SP 205 to transmit the SIFS burst. AP 105-a may thus signal a subsequent TWT SP 205 during which communication may resume.

In some cases, STA 115-a may wake up according to a broadcast TWT and wait for a trigger frame before it sends a PS-Poll. AP 105-a may then, for instance, send a DL MAC protocol data unit (MPDU) to STA 115-a and may receive an acknowledgment (ACK) in response. Such methods may facilitate coexistence mechanisms that depend on fast turn-around times following the transmission of a PS-Poll. If additional data is to be sent to STA 115-a, the same sequence is repeated, and STA 115-a may go back to sleep if an outside broadcast TWT or data exchange is completed.

In some examples, STA 115-b may have multi-channel concurrency (MCC) or Bluetooth (BT) coexistence capabilities and decide to opt out of the TWT process, such as when it may not stay awake for the duration of the TWT SP 205. STA 115-b may thus opt out of responding to the trigger frame sent by AP 105-a, and STA 115-b may continue with its coexistence procedures without sending a response and staying awake for a broadcast TWT SP 205.

In some cases, a service period termination time (SPTT) may be used, where the SP duration may be specified by STA 115-a, as opposed to the broadcast TWT. For example, if AP 105-a chooses to honor the SPTT from STA 115-a, STA 115-a may send its data (e.g., with PM field equal to 1) and AP 105-a will refrain from servicing the STA 115-a.

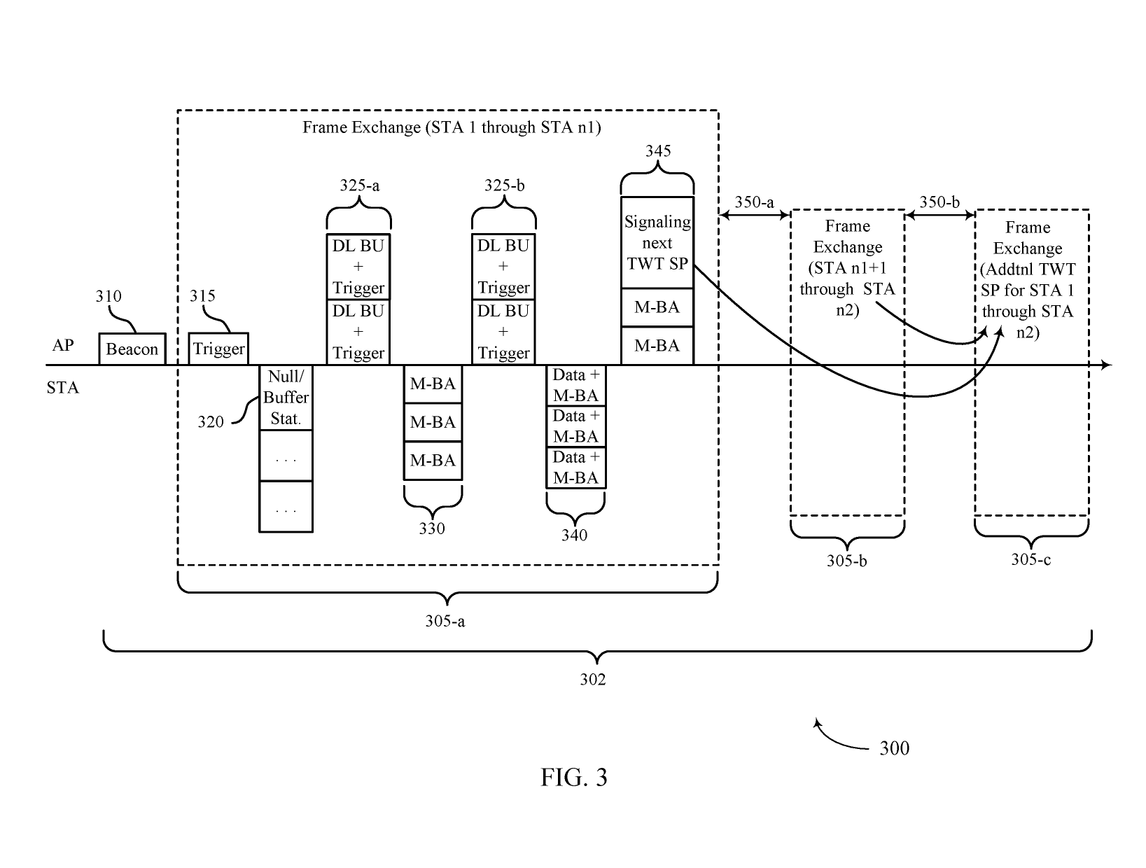

FIG. 3 illustrates an example of a TWT SP configuration 300 for dynamic broadcast time to wake service period allocation in accordance with various aspects of the present disclosure. In some cases, TWT SP configuration 300 may represent aspects of techniques performed by an AP 105 or an STA 115 as described with reference to FIGS. 1-2. TWT SP configuration 300 may illustrate an example of multiple TWT SPs within a beacon period, where each TWT SP may dynamically serve a subset of STAs 115.

As an example, a beacon frame 310 may announce that a beacon period 302 includes multiple TWT SPs 305, where each TWT SP 305 may service a different subset of STAs 115. For example, a first TWT SP 305-a may service STA 1 through STA n1 and a second TWT SP 305-b may service STA n1+1 through STA n2. Any STAs 115 that may still need RUs to communicate may be combined and serviced using a third TWT SP 305-c that is announced by the AP 105 towards the end of the individual TWT SP 305 (e.g., based on traffic needs).

In some cases, the beacon frame 310 may indicate the presence of additional information that follows the beacon frame 310. The additional information may include the presence and timing of TWT SP 305-a (or an additional TWT SP 305). For example, the beacon frame 310 may indicate the timing of first TWT SP 305-a for a first subset of STAs 115 and the timing of second TWT SP 305-b for a different subset of STAs 115, but may exclude the timing of third TWT SP 305-c. Prior to the first TWT SP 305-a, an AP 105 may transmit a beacon frame 310 that indicates the transmission time of a trigger frame 315 within the TWT SP 305-a.

In some cases, one or more trigger frames 315 may be scheduled during a given beacon period. In some examples, a TWT IE within either a beacon frame 310 or trigger frame 315 may be used to indicate that the STAs 115 signaled in the trigger frame will be served in TWT SP 305-a. Additionally or alternatively, the TWT IE may indicate whether TWT SP 305-a is intended to serve only UL, or both UL and DL communications with the indicated STAs 115. As compared to back-to-back solicited TWT SP, the participation (i.e., all the allowed STAs 115) in each of the TWT SPs 305 may be dynamic, as opposed to a static participation as may be found in solicited TWT methods.

In some cases, a TWT SP used for DL traffic may be inferred from a TIM bit and a TWT SP used for UL traffic may be implicitly indicated by the presence of the trigger frame 315. For the STAs 115 that are not indicated in the trigger frame 315 (e.g., the remaining subset of STAs 115 that will not be communicating during TWT SP 305-a), a bit within the trigger frame (e.g., a cascade bit) may be used to signal to those STAs 115 that they may go to sleep for the duration of TWT SP 305-a.

One or more STAs 115 that are indicated by the beacon frame 310 or by the trigger frame 315 may subsequently send a response frame 320 that includes a buffer status. The buffer status may include an indication of the type of UL data or traffic the STA 115 is ready to send (e.g., information about each traffic class that is ready for UL transmission), an indication of the amount of data to send, and an indication that the STA 115 is awake. In some cases, the indication that the STA 115 is awake may be implicit based on the transmission of response frame 320. In one example, an STA 115 may respond by sending one or more QoS null frames that correspond to each traffic type, and may carry the amount of data for each traffic type. The STA 115 may additionally or alternatively send a single QoS null frame with the total amount of data.

Following receipt of the response frame 320 from the one or more STAs 115, the AP 105 may be aware of the buffer status for at least a subset of the one or more STAs 115 (e.g., the STAs 115 who were included in the trigger frame 315), but the AP 105 may not be able to schedule UL RUs. For example, the AP 105 may not have enough time to process the response frame 320 received from the STA(s) 115. However, the AP 105 may continue with sending DL transmission 325-a during TWT SP 305-a, where DL transmission 325-a may include a DL BU and a trigger. In some cases, this communication may incline towards SIFS bursts. In response to the DL transmission 325-a received from the AP 105, STAs 115 may transmit a multi-TID block acknowledgment (M-BA) 330, where multiple MPDUs from the AP 105 may be acknowledged together.

After DL transmission 325-a (which may be sent using OFDMA/MU communication), the SIFS bursts may continue to allow for UL RU allocation for UL transmissions. For example, the AP 105 may send DL transmission 325-b that include DL BU and a trigger. The STA 115 may then send UL data and M-BA frames 340 to the AP 105 based on the received trigger. In some examples, DL transmission 325-b may include either DL data or the trigger, or both. Based on the duration of the TWT SP 305-a, DL transmission 325-b and any corresponding response from the STA(s) 115 may repeat. In some cases, DL transmission 325-b may not be present in TWT SP 305-a, such as when no additional data is available to be communicated, or if there is not enough time remaining in TWT SP 305-a to communicate.

If there is enough time in the TWT SP 305-a remaining, and the data exchange is complete, the one or more STAs 115 may subsequently go to sleep. In some cases, if there are STAs 115 that have additional data (either DL or UL), the AP 105 may signal a next TWT SP 305 for these STAs 115 to communicate. The next TWT SP 305 may be within the same beacon period 302 and may include any of the already scheduled TWT SPs 305 indicated in the beacon frame 310. In some cases, the next TWT SP 305 may be in a different beacon period.

For example, AP 105 may transmit signaling 345 that identifies TWT SP 305-c that the STA 115 (or multiple STAs 115) may use to communicate the additional data. The signaling 345 may also include a multi-STA BA sent from the AP 105 in response to UL data received from the one or more STAs 115. In some cases, the signaling 345 may re-use a TWT IE frame with content that includes the TWT SP signaling. That is, the TWT IE may be re-used (or modified with changes to fields) to include signaling that indicates an additional TWT SP 305 during which an STA 115 may communicate.

In some cases, the signaled STA(s) 115 may include STAs 115 that have not entered power save mode and have DL or UL data, or both. For example, an STAs 115 that has additional data, a last data frame in a DL transmission may include an indication of such using a bit (e.g., a more data bit set to 1). Similarly, an STA 115 that has additional UL data may not have emptied an UL queue. In some cases, the AP 105 may proactively schedule a next TWT SP 305 based on conditions of the BSS. For example, the AP 105 may identify the traffic needs of a subset of STAs 115 and proactively determine that TWT SP 305-c may be used to complete communication.

In some cases, a PM bit for the one or more STAs 115 may be set to zero, and the STAs 115 may be expected to be awake during a third TWT SP 305-c. In such cases the AP 105 may include in signaling 345 whether transmissions of DL data to the STAs 115 may wait until TWT SP 305-c. The AP 105 may transmit the signaling 345 indicating the third TWT SP 305-c via a unicast transmission, or via a multicast transmission to all (or a subset) of the STAs 115. Additionally or alternatively, the AP 105 may transmit the signaling 345 using a single message, which may indicate that all STAs 115 that have received all of the data currently scheduled (e.g., by setting a more data bit equal to 1), and have not signaled that they do not have any UL data, may implicitly be awake at the signaled third TWT SP 305-c (e.g., using the TWT IE).

In some cases, there may be no restriction on the one or more STAs 115 to transmit on UL. For example, an STA 115 may determine that it has data that cannot, or preferably should not, wait for the next TWT SP 305 to be sent. The STA 115 may then decide to transmit on UL regardless of the signaled TWT SP 305-c.

At the end of first TWT SP 305-a, a first doze period 350-a may begin where there may be no communications scheduled, and STAs 115 may enter into a sleep state (e.g., a low power state in which portions of the STA's 115 RF chain or other componentry is powered down) to save power. Following the first doze period 350-a, the second TWT SP 305-b may begin, where another subset of STAs 115 (e.g., STA n1+1 through STA n2) may be serviced. The second TWT SP 305-b may include the same or different steps described with reference to the first TWT SP 305-a. For example, the AP 105 may communicate with the different subset of STAs 115 using more or less steps as described with reference to TWT SP 305-a.

TWT SP 305-b may be followed by a second doze period 350-b, where there may be no communication scheduled. Subsequently, TWT SP 305-c may be used to service any additional STAs 115 that have additional DL or UL data to communicate. The STAs 115 that are serviced by TWT SP 305-c may include one or more STAs 115 serviced during TWT SP 305-a or TWT SP 305-b, or both. For example, TWT SP 305-c may be used for communications with STA 1 through STA n2.

In some cases, second TWT SP 305-b and third TWT SP 305-c may be combined into a single TWT SP 305. Additionally or alternatively, third TWT SP 305-c may occur prior to second TWT SP 305-b (e.g., to meet the delay or latency requirements of the queued data traffic type). In some examples, all TWT SPs may be a different duration. That is, the duration of each TWT SP 305 may be dynamically determined by the AP 105 based on traffic conditions in the BSS, which may reduce underutilization of resources.

In some examples, the STAs 115 that are served in first TWT SP 305-a may additionally or alternatively communicate in different TWT SPs 305 subsequent to the first TWT SP 305-a. For example, a first STA 115 may communicate during first TWT SP 305-a and subsequently communicate during second TWT SP 305-b, where a second STA 115 may communicate during first TWT SP 305-a and subsequently communicate during third TWT SP 305-c.

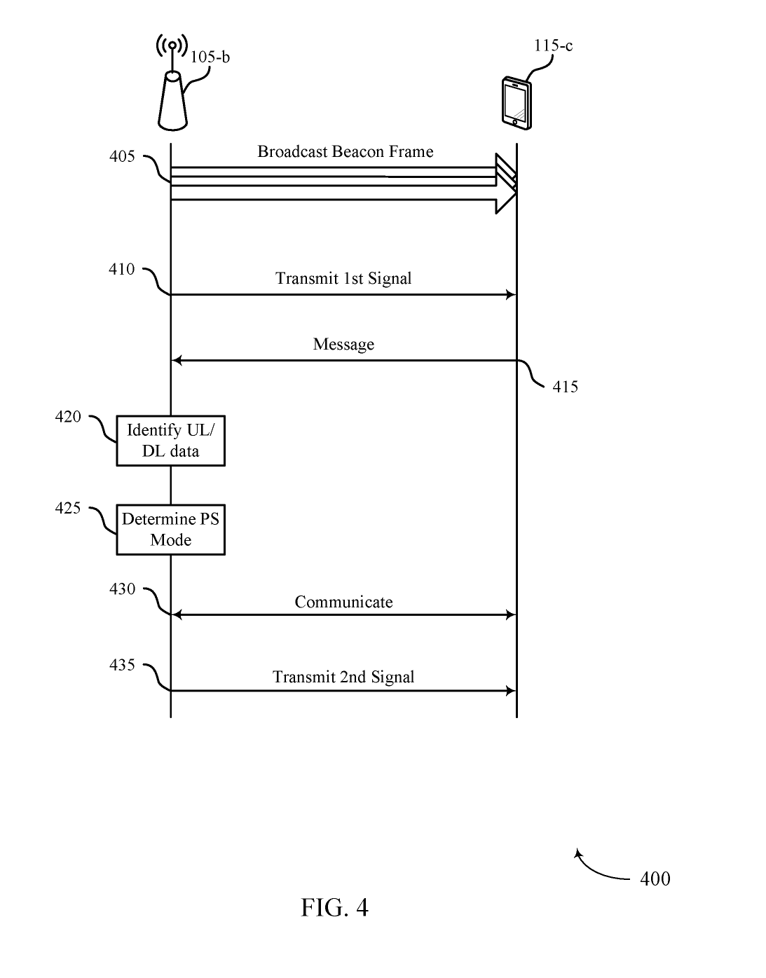

FIG. 4 illustrates an example of a process flow 400 for a system that supports dynamic broadcast time to wake service period allocation in accordance with various aspects of the present disclosure. Process flow 400 may include AP 105-b and STA 115-c which may be examples of the corresponding devices described with reference to FIG. 1-2.

At step 405, AP 105-b may broadcast, and STA 115-c may receive, a beacon frame that identifies a timing for a first TWT SP and a second TWT SP for a BSS. In some cases, a beacon period initiated by the beacon frame includes the first TWT SP and the second TWT SP. Additionally or alternatively, a beacon period initiated by the beacon frame may include the first TWT SP, and a subsequent beacon period may include the second TWT SP.

At step 410, AP 105-b may transmit a first signal that indicates the first TWT SP for a subset of STAs 115 of the BSS that includes AP 105-b. In some cases, the first signal includes a trigger frame for the subset of STAs 115. In some cases, the beacon frame may indicate a timing of the first signal. The first signal may include a first broadcast message transmitted to the subset of STAs 115.

At step 415, AP 105-b may receive a message from STA 115-c during the first TWT SP. AP 105-b may also receive a message from STA 115-c that indicates a buffer status of STA 115-c. In some cases, AP 105-b may receive a message from STA 115-c that indicates a requested termination time for the first TWT SP, and AP 105-b may determine to transmit a second message based on the received message.

At step 420, AP 105-b may identify, during the first TWT SP, a presence of uplink or downlink data for STA 115-c of the subset of STAs 115. The presence of uplink data for STA 115-c may be identified based on the received message (e.g., a buffer status report). At step 425, AP 105-b may determine a power saving mode of STA 115-c. At step 430, AP 105-b and STA 115-c may communicate during the first TWT SP. The communication at step 430 may include AP 105-b transmitting a first downlink message to STA 115-c during the first TWT SP. In some cases, receiving uplink data from STA 115-c may be based on receiving the buffer status.

At step 435, AP 105-b may transmit the second signal that indicates a second TWT SP for STA 115-c based on identifying the presence of uplink or downlink data during the first TWT SP. In some cases, the second signal is transmitted to STA 115-c based on the determination of the power saving mode of STA 115-c. The second signal may include a second broadcast message transmitted to STA 115-c and one or more additional STAs 115 of the subset. The second signal may, in some examples, be a unicast message transmitted to STA 115-c.

In some cases, AP 105-b may transmit a second downlink message to STA 115-c during the second TWT SP, where the second downlink message transmission is based on the identified presence of downlink data during the first TWT SP. The second TWT SP may include a next TWT SP following the first TWT SP, and AP 105-b may communicate with STA 115-c and another subset of STAs 115 of the BSS during the second TWT SP.

In some examples, AP 105-b may communicate with another subset of STAs 115 of the BSS during a third TWT SP, where the other subset of STAs 115 excludes STAs 115 triggered for the first TWT SP (e.g., STA 115-c). In some cases, the second TWT SP may occur before or after the third TWT SP. AP 105-b may identify, during the third TWT SP, a presence of uplink or downlink data for an STA 115 of the other subset of STAs 115. AP 105-b may then transmit a third signal that indicates the second TWT SP for the STA 115 of the other subset of STAs 115 and communicate with the STA 115 of the other subset of STAs 115 during the second TWT SP. In some cases, AP 105-b may communicate with another subset of STAs 115 of the BSS during a third TWT SP, where the other subset of STAs 115 includes STAs 115 triggered for the first TWT SP.

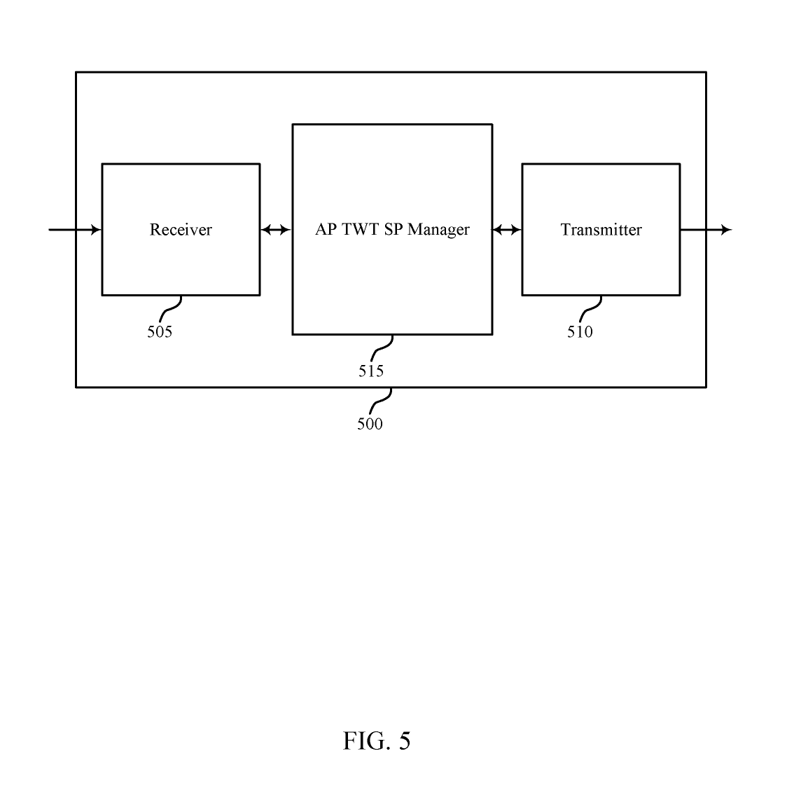

FIG. 5 shows a block diagram of a wireless device 500 that supports dynamic broadcast time to wake service period allocation in accordance with various aspects of the present disclosure. Wireless device 500 may be an example of aspects of an AP 105 described with reference to FIGS. 1 and 2. Wireless device 500 may include receiver 505, transmitter 510 and AP TWT SP manager 515. Wireless device 500 may also include a processor. Each of these components may be in communication with one another.

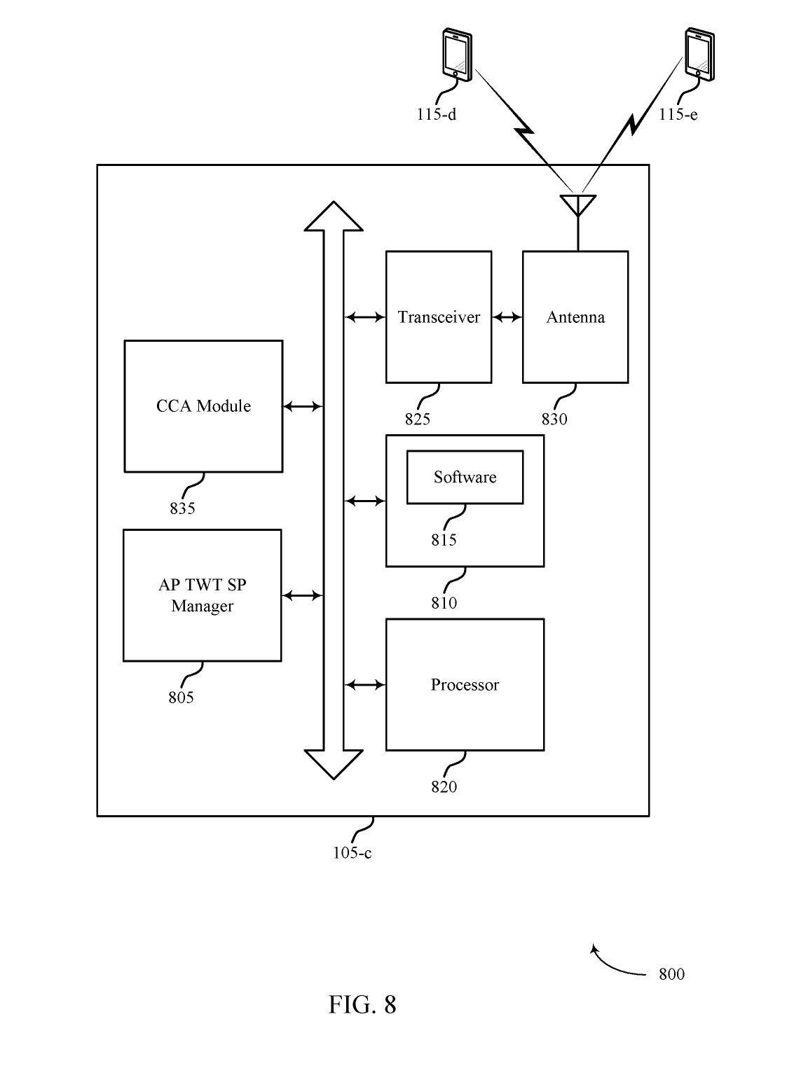

The receiver 505 may receive information such as packets, user data, or control information associated with various information channels (e.g., control channels, data channels, and information related to dynamic broadcast time to wake service period allocation, etc.). Information may be passed on to other components of the device. The receiver 505 may be an example of aspects of the transceiver 825 described with reference to FIG. 8.

The transmitter 510 may transmit signals received from other components of wireless device 500. In some examples, the transmitter 510 may be collocated with a receiver in a transceiver module. For example, the transmitter 510 may be an example of aspects of the transceiver 825 described with reference to FIG. 8. The transmitter 510 may include a single antenna, or it may include a plurality of antennas.

The AP TWT SP manager 515 may transmit a first signal that indicates a first TWT SP for a subset of STAs 115 of a BSS that includes the AP, identify, during the first TWT SP, a presence of uplink or downlink data for an STA 115 of the subset of STAs 115, and transmit a second signal that indicates a second TWT SP for the STA 115 based on identifying the presence of uplink or downlink data during the first TWT SP. The AP TWT SP manager 515 may also be an example of aspects of the AP TWT SP manager 805 described with reference to FIG. 8.

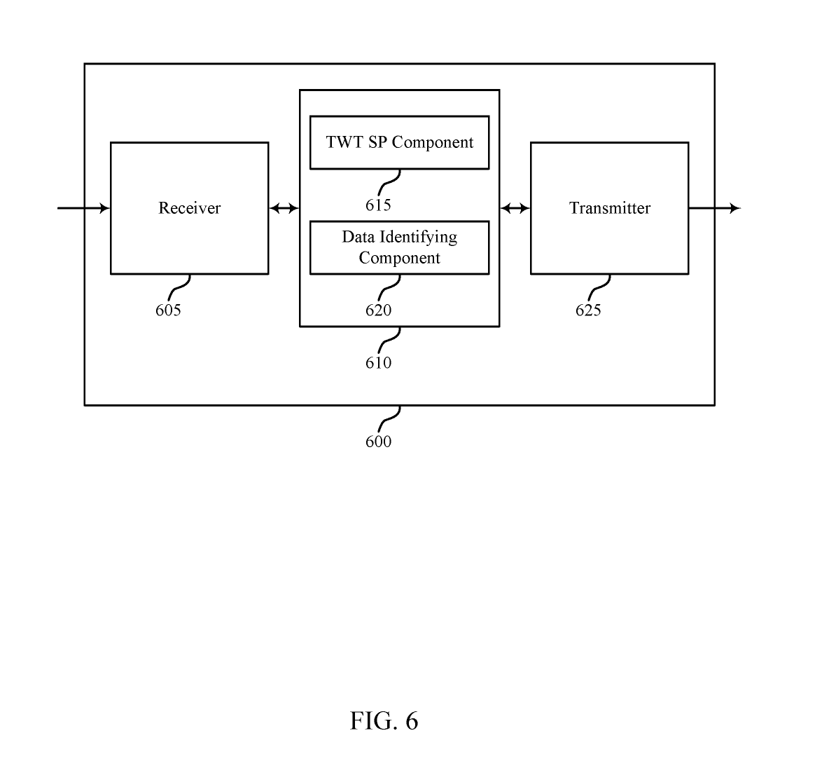

FIG. 6 shows a block diagram of a wireless device 600 that supports dynamic broadcast time to wake service period allocation in accordance with various aspects of the present disclosure. Wireless device 600 may be an example of aspects of a wireless device 500 or an AP 105 described with reference to FIGS. 1, 2 and 5. Wireless device 600 may include receiver 605, AP TWT SP manager 610 and transmitter 625. Wireless device 600 may also include a processor. Each of these components may be in communication with one another.

The receiver 605 may receive information which may be passed on to other components of the device. The receiver 605 may also perform the functions described with reference to the receiver 505 of FIG. 5. The receiver 605 may be an example of aspects of the transceiver 825 described with reference to FIG. 8.

The AP TWT SP manager 610 may be an example of aspects of AP TWT SP manager 515 described with reference to FIG. 5. The AP TWT SP manager 610 may include TWT SP component 615 and data identifying component 620. The AP TWT SP manager 610 may be an example of aspects of the AP TWT SP manager 805 described with reference to FIG. 8. The TWT SP component 615 may transmit a first signal that indicates a first TWT SP for a subset of STAs 115 of a BSS that includes the AP 105, and transmit a second signal that indicates a second TWT SP for the STA 115 based on identifying the presence of uplink or downlink data during the first TWT SP.

In some cases, the first signal includes a first broadcast message transmitted to the subset of STAs 115 and the second signal includes a second broadcast message transmitted to the STA 115 and one or more additional STAs 115 of the subset. In some cases, the first signal includes a broadcast message transmitted to the subset of STAs 115 and the second signal includes a unicast message transmitted to the STA 115. In some cases, the second TWT SP includes a next TWT SP following the first TWT SP.

The data identifying component 620 may identify, during the first TWT SP, a presence of uplink or downlink data for an STA 115 of the subset of STAs 115. The transmitter 625 may transmit signals received from other components of wireless device 600. In some examples, the transmitter 625 may be collocated with a receiver in a transceiver module. For example, the transmitter 625 may be an example of aspects of the transceiver 825 described with reference to FIG. 8. The transmitter 625 may utilize a single antenna, or it may utilize a plurality of antennas.

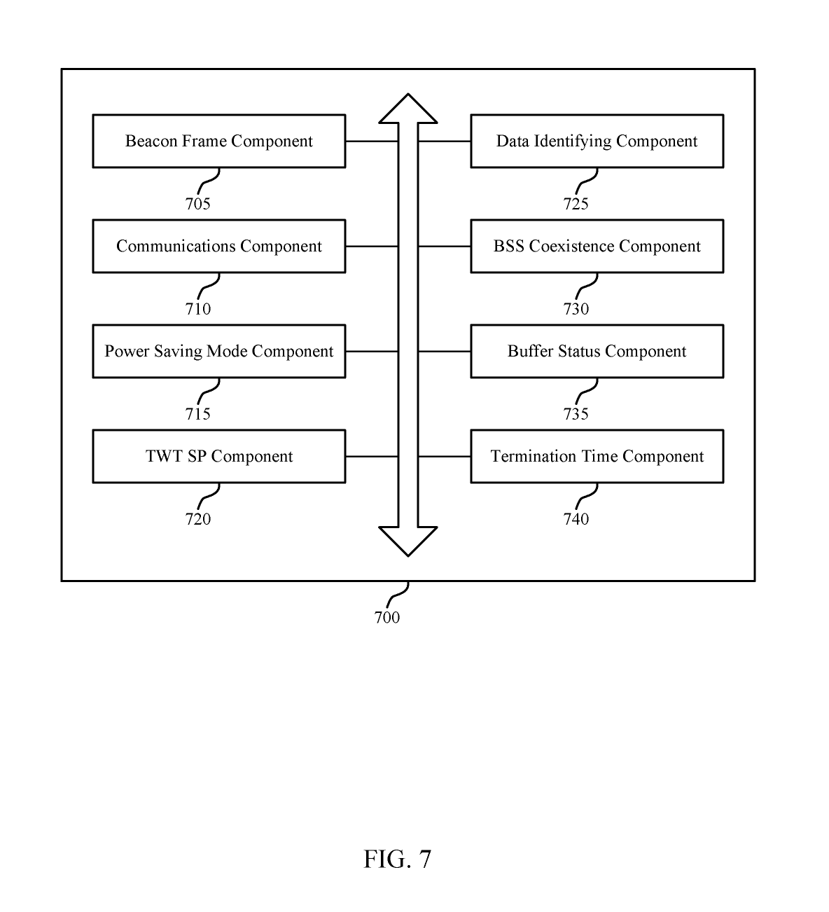

FIG. 7 shows a block diagram of an AP TWT SP manager 700 which may be an example of the corresponding component of wireless device 500 or wireless device 600 in accordance with various aspects of the present disclosure. That is, AP TWT SP manager 700 may be an example of aspects of AP TWT SP manager 515 or AP TWT SP manager 610 described with reference to FIGS. 5 and 6. The AP TWT SP manager 700 may also be an example of aspects of the AP TWT SP manager 805 described with reference to FIG. 8.

The AP TWT SP manager 700 may include beacon frame component 705, communications component 710, power saving mode component 715, TWT SP component 720, data identifying component 725, BSS coexistence component 730, buffer status component 735 and termination time component 740. Each of these modules may communicate, directly or indirectly, with one another (e.g., via one or more buses).

The beacon frame component 705 may broadcast a beacon frame that identifies a timing for the first TWT SP and the second TWT SP for the BSS, where the first signal includes a trigger frame for the subset of STAs 115. In some cases, a beacon period initiated by the beacon frame includes the first TWT SP, and where a subsequent beacon period includes the second TWT SP. In some cases, the beacon frame indicates a timing of the first signal. In some cases, a beacon period initiated by the beacon frame includes the first TWT SP and the second TWT SP.

The communications component 710 may receive a message from the STA 115 during the first TWT SP, where the presence of uplink data for the STA 115 is identified based on the received message, and transmit a first downlink message to the STA 115 during the first TWT SP. In some examples, the communications component 710 may transmit a second downlink message to the STA 115 during the second TWT SP, where the second downlink message transmission is based on the identified presence of downlink data during the first TWT SP. In some cases, the communications component 710 may communicate with another subset of STAs 115 of the BSS during a third TWT SP, where the other subset of STAs 115 excludes STAs 115 triggered for the first TWT SP.

The communications component 710 may also identify, during the third TWT SP, a presence of uplink or downlink data for an STA 115 of the other subset of STAs 115, transmit a third signal that indicates the second TWT SP for the STA 115 of the other subset of STAs 115, and communicate with the STA 115 of the other subset of STAs 115 during the second TWT SP. In some examples, the communications component 710 may communicate with another subset of STAs 115 of the BSS during a third TWT SP, where the other subset of STAs 115 includes STAs 115 triggered for the first TWT SP. Additionally or alternatively, the communications component 710 may communicate with the STA 115 and another subset of STAs 115 of the BSS during the second TWT SP, and receive uplink data from the STA 115 during an interval between the first TWT SP and the second TWT SP. In some cases, the second TWT SP occurs before the third TWT SP. In some cases, the second TWT SP occurs after the third TWT SP.

The power saving mode component 715 may determine a power saving mode of the STA 115, where the second signal is transmitted to the STA 115 based on the determination of the power saving mode of the STA 115. The TWT SP component 720 may transmit a first signal that indicates a first TWT SP for a subset of STAs 115 of a BSS that includes the AP 115, and transmit a second signal that indicates a second TWT SP for the STA 115 based on identifying the presence of uplink or downlink data during the first TWT SP.

The data identifying component 725 may identify, during the first TWT SP, a presence of uplink or downlink data for an STA 115 of the subset of STAs 115. The BSS coexistence component 730 may determine an operating mode of the STA 115, where the first signal or the second signal is transmitted based on the determination of the operating mode. In some cases, the signaled operating mode may include a power save mode or an indication that the STA 115 is opting out of responding to the trigger frame (e.g., if the STA 115 is in an out-of-band coexistence operating mode). An out-of-band coexistence operating mode may include a mode that employs Bluetooth, for example, to facilitate access to the wireless medium.

The buffer status component 735 may receive a message from the STA 115 that indicates a buffer status of the STA 115, and receive uplink data from the STA 115 based on receiving the buffer status. The termination time component 740 may receive a message from the STA 115 that indicates a requested termination time for the first TWT SP, and determine to transmit a second message based on the received message.

FIG. 8 shows a diagram of a system 800 including a device that supports dynamic broadcast time to wake service period allocation in accordance with various aspects of the present disclosure. For example, system 800 may include AP 105-c, which may be an example of a wireless device 500, a wireless device 600, or an AP 105 as described with reference to FIGS. 1, 2 and 4 through 7.

AP 105-c may also include AP TWT SP manager 805, memory 810, processor 820, transceiver 825, antenna 830 and CCA module 835. Each of these modules may communicate, directly or indirectly, with one another (e.g., via one or more buses). The AP TWT SP manager 805 may be an example of an AP TWT SP manager as described with reference to FIGS. 5 through 7.

The memory 810 may include random access memory (RAM) and read only memory (ROM). The memory 810 may store computer-readable, computer-executable software including instructions that, when executed, cause the processor to perform various functions described herein (e.g., dynamic broadcast time to wake service period allocation, etc.). In some cases, the software 815 may not be directly executable by the processor but may cause a computer (e.g., when compiled and executed) to perform functions described herein. The processor 820 may include an intelligent hardware device, (e.g., a central processing unit (CPU), a microcontroller, an application specific integrated circuit (ASIC), etc.).

The transceiver 825 may communicate bi-directionally, via one or more antennas, wired, or wireless links, with one or more networks, as described above. For example, the transceiver 825 may communicate bi-directionally with an AP 105 or an STA 115. The transceiver 825 may also include a modem to modulate the packets and provide the modulated packets to the antennas for transmission, and to demodulate packets received from the antennas. In some cases, the wireless device may include a single antenna 830. However, in some cases the device may have more than one antenna 830, which may be capable of concurrently transmitting or receiving multiple wireless transmissions. CCA module 835 may perform a listen-before-talk (LBT) procedure, such as a CCA, for access to an unlicensed spectrum as described above with reference to FIG. 1.

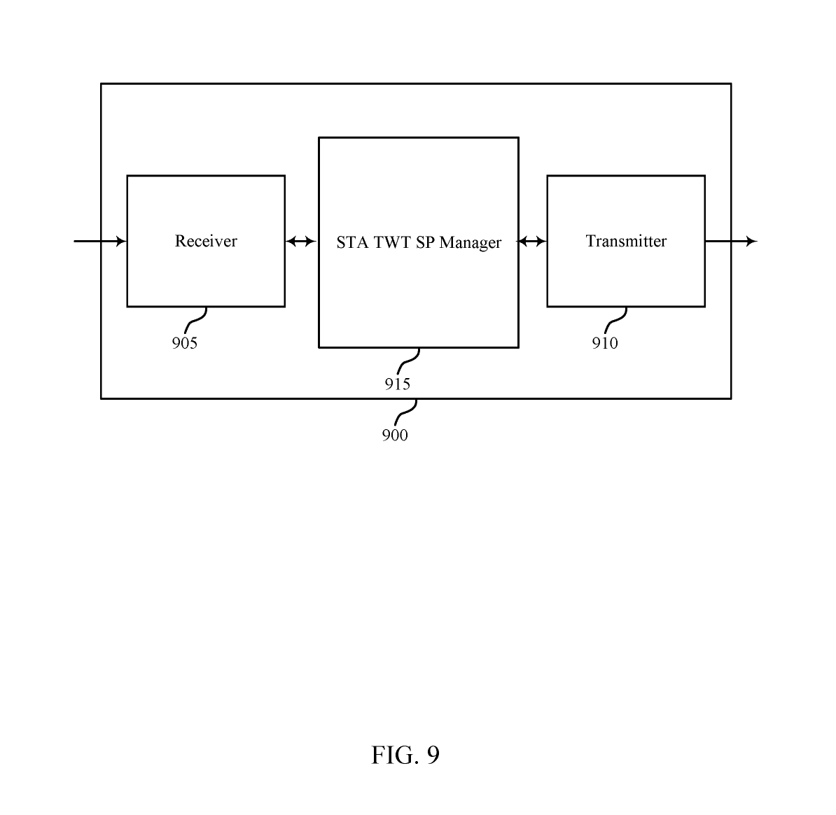

FIG. 9 shows a block diagram of a wireless device 900 that supports dynamic broadcast time to wake service period allocation in accordance with various aspects of the present disclosure. Wireless device 900 may be an example of aspects of an STA 115 described with reference to FIGS. 1 and 2. Wireless device 900 may include receiver 905, transmitter 910 and STA TWT SP manager 915. Wireless device 900 may also include a processor. Each of these components may be in communication with one another.

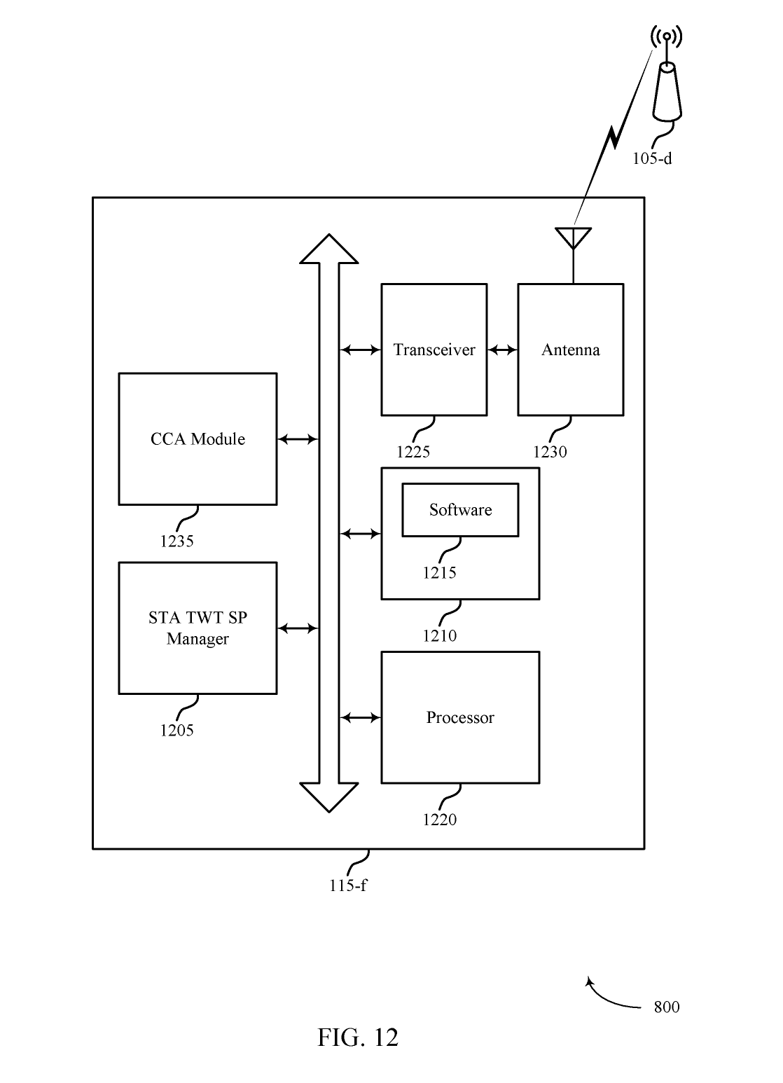

The receiver 905 may receive information such as packets, user data, or control information associated with various information channels (e.g., control channels, data channels, and information related to dynamic broadcast time to wake service period allocation, etc.). Information may be passed on to other components of the device. The receiver 905 may be an example of aspects of the transceiver 1225 described with reference to FIG. 12.

The transmitter 910 may transmit signals received from other components of wireless device 900. In some examples, the transmitter 910 may be collocated with a receiver in a transceiver module. For example, the transmitter 910 may be an example of aspects of the transceiver 1225 described with reference to FIG. 12. The transmitter 910 may include a single antenna, or it may include a plurality of antennas.

The STA TWT SP manager 915 may receive from an AP 105 a first signal that indicates a first TWT SP, communicate with the AP 105 during the first TWT SP, and receive, during the first TWT SP, a second signal that indicates a second TWT SP for communicating with the AP 105. The STA TWT SP manager 915 may also be an example of aspects of the STA TWT SP manager 1205 described with reference to FIG. 12.

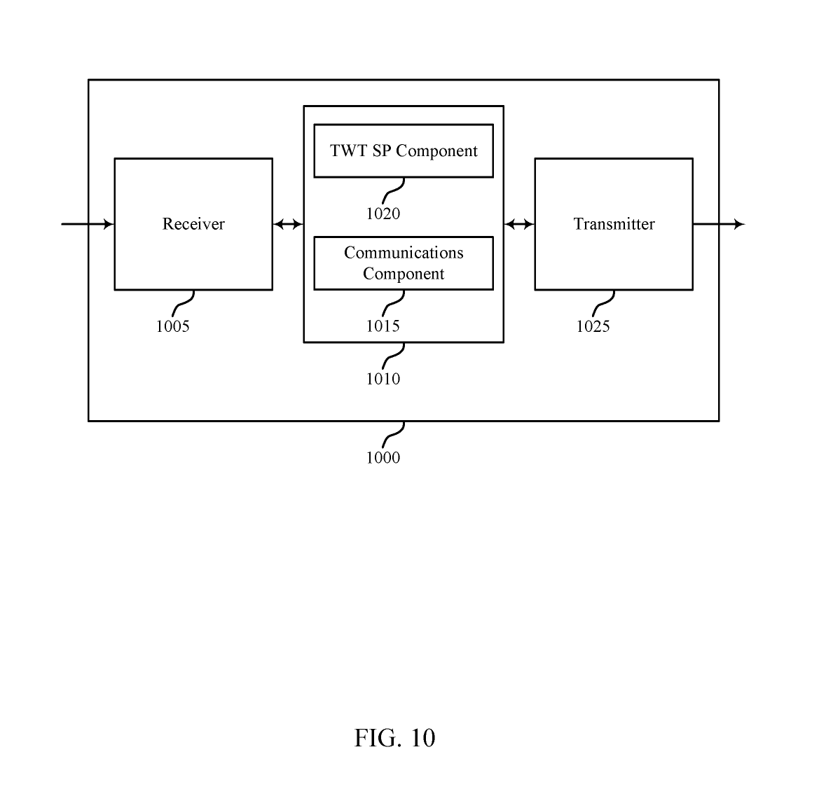

FIG. 10 shows a block diagram of a wireless device 1000 that supports dynamic broadcast time to wake service period allocation in accordance with various aspects of the present disclosure. Wireless device 1000 may be an example of aspects of a wireless device 900 or an STA 115 described with reference to FIGS. 1, 2 and 9. Wireless device 1000 may include receiver 1005, STA TWT SP manager 1010 and transmitter 1025. Wireless device 1000 may also include a processor. Each of these components may be in communication with one another.

The receiver 1005 may receive information which may be passed on to other components of the device. The receiver 1005 may also perform the functions described with reference to the receiver 905 of FIG. 9. The receiver 1005 may be an example of aspects of the transceiver 1225 described with reference to FIG. 12.

The STA TWT SP manager 1010 may be an example of aspects of STA TWT SP manager 915 described with reference to FIG. 9. The STA TWT SP manager 1010 may include communications component 1015 and TWT SP component 1020. The STA TWT SP manager 1010 may be an example of aspects of the STA TWT SP manager 1205 described with reference to FIG. 12.

The communications component 1015 may communicate with the AP 105 during the first TWT SP, transmit a message during the first TWT SP, where the message indicates a presence of uplink data. In some cases, the communications component 1015 may receive a first downlink message during the first TWT SP, receive a second downlink message during the second TWT SP, where the second downlink message transmission includes data buffered at the AP 105 during the first TWT SP, and transmit uplink data from the STA 115 during an interval between the first TWT SP and the second TWT SP.

The TWT SP component 1020 may receive from an AP 105 a first signal that indicates a first TWT SP, and receive, during the first TWT SP, a second signal that indicates a second TWT SP for communicating with the AP 105. In some cases, the first signal includes a broadcast message transmitted to the subset of STAs 115 and the second signal includes a unicast message transmitted to the STA 115.

The transmitter 1025 may transmit signals received from other components of wireless device 1000. In some examples, the transmitter 1025 may be collocated with a receiver in a transceiver module. For example, the transmitter 1025 may be an example of aspects of the transceiver 1225 described with reference to FIG. 12. The transmitter 1025 may utilize a single antenna, or it may utilize a plurality of antennas.

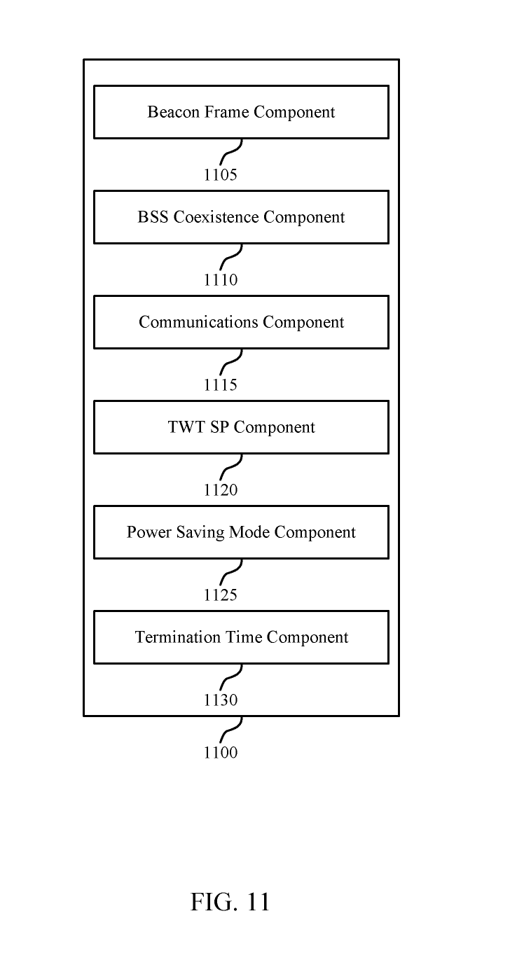

FIG. 11 shows a block diagram of an STA TWT SP manager 1100 which may be an example of the corresponding component of wireless device 900 or wireless device 1000 in accordance with various aspects of the present disclosure. That is, STA TWT SP manager 1100 may be an example of aspects of STA TWT SP manager 915 or STA TWT SP manager 1010 described with reference to FIGS. 9 and 10. The STA TWT SP manager 1100 may also be an example of aspects of the STA TWT SP manager 1205 described with reference to FIG. 12.

The STA TWT SP manager 1100 may include beacon frame component 1105, BSS coexistence component 1110, communications component 1115, TWT SP component 1120, power saving mode component 1125 and termination time component 1130. Each of these modules may communicate, directly or indirectly, with one another (e.g., via one or more buses).

The beacon frame component 1105 may receive a beacon frame that identifies a timing for the first TWT SP and the second TWT SP for a BSS, where the first signal includes a trigger frame for a subset of STAs 115 of the BSS. In some cases, a beacon period initiated by the beacon frame includes the first TWT SP and the second TWT SP. In some cases, a beacon period initiated by the beacon frame includes the first TWT SP, and where a subsequent beacon period includes the second TWT SP. In some cases, the beacon frame indicates a timing of the first signal.

The BSS coexistence component 1110 may transmit a message that indicates a buffer status, transmit uplink data during the first TWT SP or the second TWT SP based on transmitted the buffer status, and transmit a message to the AP 105 that indicates an operating mode, where the first signal or the second signal is transmitted based on the indication of the operating mode. In some cases, the signaled operating mode may include a power save mode or an indication that the STA 115 is opting out of responding to the trigger frame (e.g., if the STA 115 is in an out-of-band coexistence operating mode). An out-of-band coexistence operating mode may include a mode that employs Bluetooth, for example, to facilitate access to the wireless medium. In some cases, upon receiving the indication of the operating mode, the AP 105 may refrain from sending data to the STA 115.

The communications component 1115 may communicate with the AP 105 during the first TWT SP. In some examples, the communications component 1115 may transmit a message during the first TWT SP, where the message indicates a presence of uplink data, and receive a first downlink message during the first TWT SP. Additionally, the communications component 1115 may receive a second downlink message during the second TWT SP, where the second downlink message transmission includes data buffered at the AP 105 during the first TWT SP, and the communications component 1115 may transmit uplink data from the STA 115 during an interval between the first TWT SP and the second TWT SP.

The TWT SP component 1120 may receive from an AP 105 a first signal that indicates a first TWT SP, and receive, during the first TWT SP, a second signal that indicates a second TWT SP for communicating with the AP 105. The power saving mode component 1125 may transmit a message to the AP 105 that indicates a power saving mode, where the second signal is transmitted based on the power saving mode of the STA 115. The termination time component 1130 may transmit a message that indicates a requested termination time for the first TWT SP, where the second message is transmitted based on the message.

FIG. 12 shows a diagram of a system 1200 including a device that supports dynamic broadcast time to wake service period allocation in accordance with various aspects of the present disclosure. For example, system 1200 may include STA 115-f, which may be an example of a wireless device 900, a wireless device 1000, or an STA 115 as described with reference to FIGS. 1, 2 and 9 through 11.

STA 115-f may also include STA TWT SP manager 1205, memory 1210, processor 1220, transceiver 1225, antenna 1230 and CCA module 1235. Each of these modules may communicate, directly or indirectly, with one another (e.g., via one or more buses). The STA TWT SP manager 1205 may be an example of an STA TWT SP manager as described with reference to FIGS. 9 through 11.

The memory 1210 may include RAM and ROM. The memory 1210 may store computer-readable, computer-executable software including instructions that, when executed, cause the processor to perform various functions described herein (e.g., dynamic broadcast time to wake service period allocation, etc.). In some cases, the software 1215 may not be directly executable by the processor but may cause a computer (e.g., when compiled and executed) to perform functions described herein. The processor 1220 may include an intelligent hardware device, (e.g., a CPU, a microcontroller, an ASIC, etc.)

The transceiver 1225 may communicate bi-directionally, via one or more antennas, wired, or wireless links, with one or more networks, as described above. For example, the transceiver 1225 may communicate bi-directionally with an AP 105 or an STA 115. The transceiver 1225 may also include a modem to modulate the packets and provide the modulated packets to the antennas for transmission, and to demodulate packets received from the antennas. In some cases, the wireless device may include a single antenna 1230. However, in some cases the device may have more than one antenna 830, which may be capable of concurrently transmitting or receiving multiple wireless transmissions. CCA module 1235 may perform a LBT procedure such as a CCA for access to an unlicensed spectrum as described above with reference to FIG. 1.

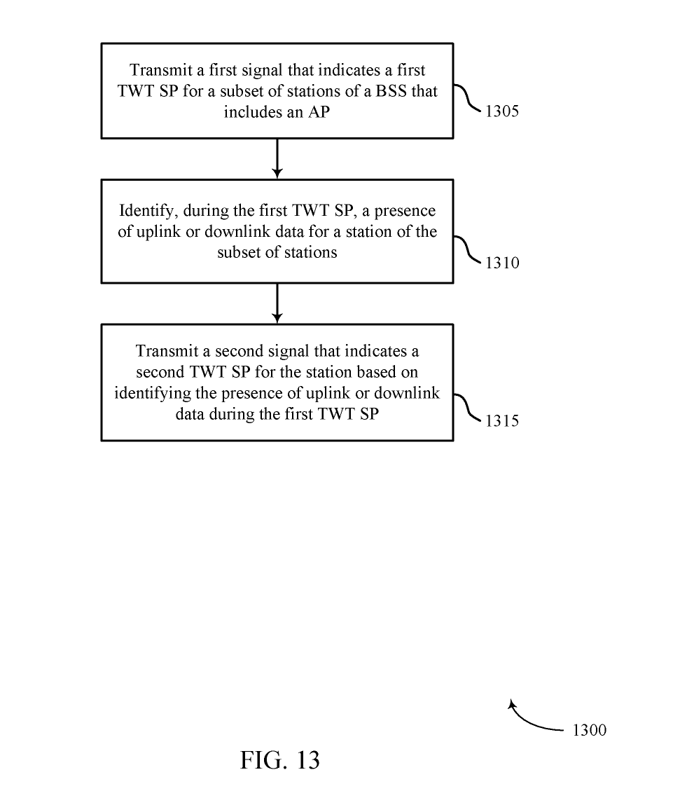

FIG. 13 shows a flowchart illustrating a method 1300 for dynamic broadcast time to wake service period allocation in accordance with various aspects of the present disclosure. The operations of method 1300 may be implemented by a device such as an AP 105 or its components as described with reference to FIGS. 1 and 2. For example, the operations of method 1300 may be performed by the AP TWT SP manager as described herein. In some examples, the AP 105 may execute a set of codes to control the functional elements of the device to perform the functions described below. Additionally or alternatively, the AP 105 may perform aspects the functions described below using special-purpose hardware.

At block 1305, the AP 105 may transmit a first signal that indicates a first TWT SP for a subset of STAs 115 of a BSS that includes the AP 105 as described above with reference to FIGS. 2 through 4. In certain examples, the operations of block 1305 may be performed by the TWT SP component as described with reference to FIG. 6.

At block 1310, the AP 105 may identify, during the first TWT SP, a presence of uplink or downlink data for an STA 115 of the subset of STAs 115 as described above with reference to FIGS. 2 through 4. In certain examples, the operations of block 1310 may be performed by the data identifying component as described with reference to FIG. 6.

At block 1315, the AP 105 may transmit a second signal that indicates a second TWT SP for the STA 115 based on identifying the presence of uplink or downlink data during the first TWT SP as described above with reference to FIGS. 2 through 4. In certain examples, the operations of block 1315 may be performed by the TWT SP component as described with reference to FIG. 6.

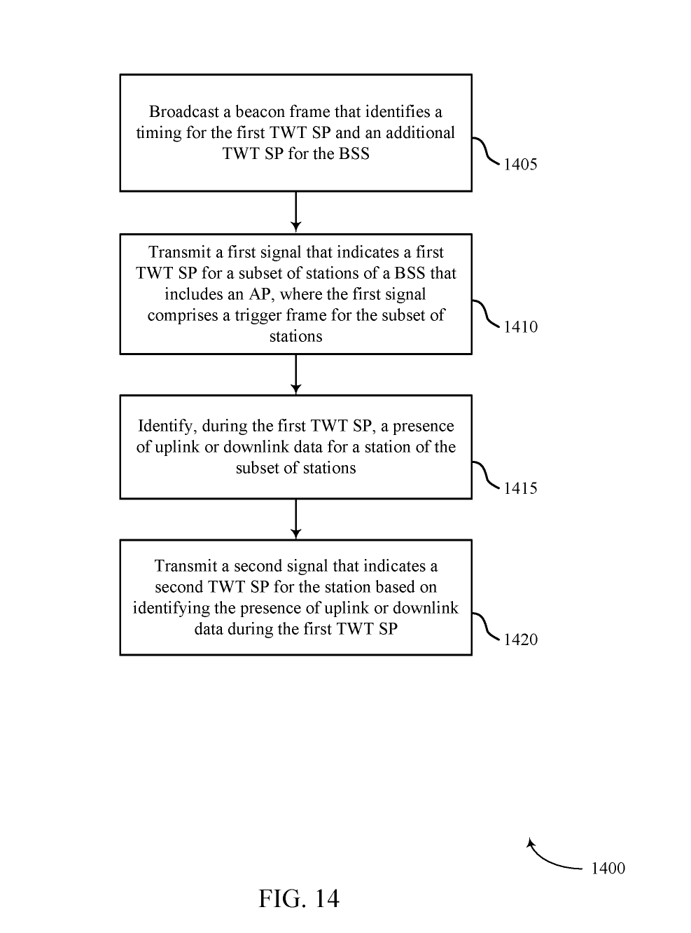

FIG. 14 shows a flowchart illustrating a method 1400 for dynamic broadcast time to wake service period allocation in accordance with various aspects of the present disclosure. The operations of method 1400 may be implemented by a device such as an AP 105 or its components as described with reference to FIGS. 1 and 2. For example, the operations of method 1400 may be performed by the AP TWT SP manager as described herein. In some examples, the AP 105 may execute a set of codes to control the functional elements of the device to perform the functions described below. Additionally or alternatively, the AP 105 may perform aspects the functions described below using special-purpose hardware.

At block 1405, the AP 105 may broadcast a beacon frame that identifies a timing for a first TWT SP and an additional TWT SP for a BSS as described above with reference to FIGS. 2 through 4. In certain examples, the operations of block 1405 may be performed by the beacon frame component as described with reference to FIG. 6.

At block 1410, the AP 105 may transmit the first signal that indicates the first TWT SP for a subset of STAs 115 of the BSS that includes the AP 105, where a first signal includes a trigger frame for the subset of STAs 115, as described above with reference to FIGS. 2 through 4. In certain examples, the operations of block 1410 may be performed by the TWT SP component as described with reference to FIG. 6.

At block 1415, the AP 105 may identify, during the first TWT SP, a presence of uplink or downlink data for an STA 115 of the subset of STAs 115 as described above with reference to FIGS. 2 through 4. In certain examples, the operations of block 1415 may be performed by the data identifying component as described with reference to FIG. 6.

At block 1420, the AP 105 may transmit a second signal that indicates a second TWT SP for the STA 115 based on identifying the presence of uplink or downlink data during the first TWT SP as described above with reference to FIGS. 2 through 4. In certain examples, the operations of block 1420 may be performed by the TWT SP component as described with reference to FIG. 6.

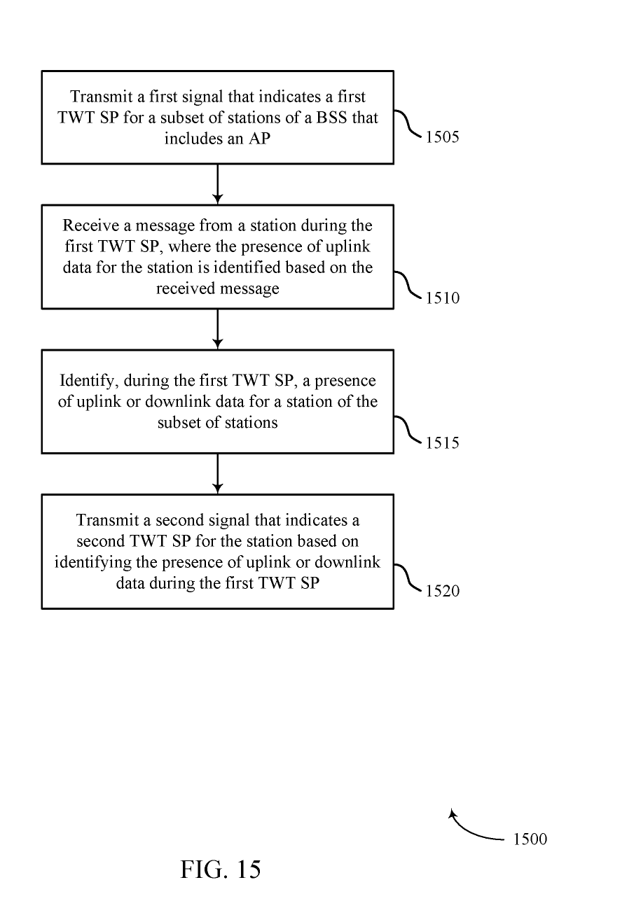

FIG. 15 shows a flowchart illustrating a method 1500 for dynamic broadcast time to wake service period allocation in accordance with various aspects of the present disclosure. The operations of method 1500 may be implemented by a device such as an AP 105 or its components as described with reference to FIGS. 1 and 2. For example, the operations of method 1500 may be performed by the AP TWT SP manager as described herein. In some examples, the AP 105 may execute a set of codes to control the functional elements of the device to perform the functions described below. Additionally or alternatively, the AP 105 may perform aspects the functions described below using special-purpose hardware.

At block 1505, the AP 105 may transmit a first signal that indicates a first TWT SP for a subset of STAs 115 of a BSS that includes the AP 105 as described above with reference to FIGS. 2 through 4. In certain examples, the operations of block 1505 may be performed by the TWT SP component as described with reference to FIG. 6.

At block 1510, the AP 105 may receive a message from an STA 115 during the first TWT SP, where the presence of uplink data for the STA 115 is identified based on the received message as described above with reference to FIGS. 2 through 4. In certain examples, the operations of block 1510 may be performed by the communications component as described with reference to FIG. 6.

At block 1515, the AP 105 may identify, during the first TWT SP, a presence of uplink or downlink data for an STA 115 of the subset of STAs 115 as described above with reference to FIGS. 2 through 4. In certain examples, the operations of block 1515 may be performed by the data identifying component as described with reference to FIG. 6.

At block 1520, the AP 105 may transmit a second signal that indicates a second TWT SP for the STA 115 based on identifying the presence of uplink or downlink data during the first TWT SP as described above with reference to FIGS. 2 through 4. In certain examples, the operations of block 1520 may be performed by the TWT SP component as described with reference to FIG. 6.

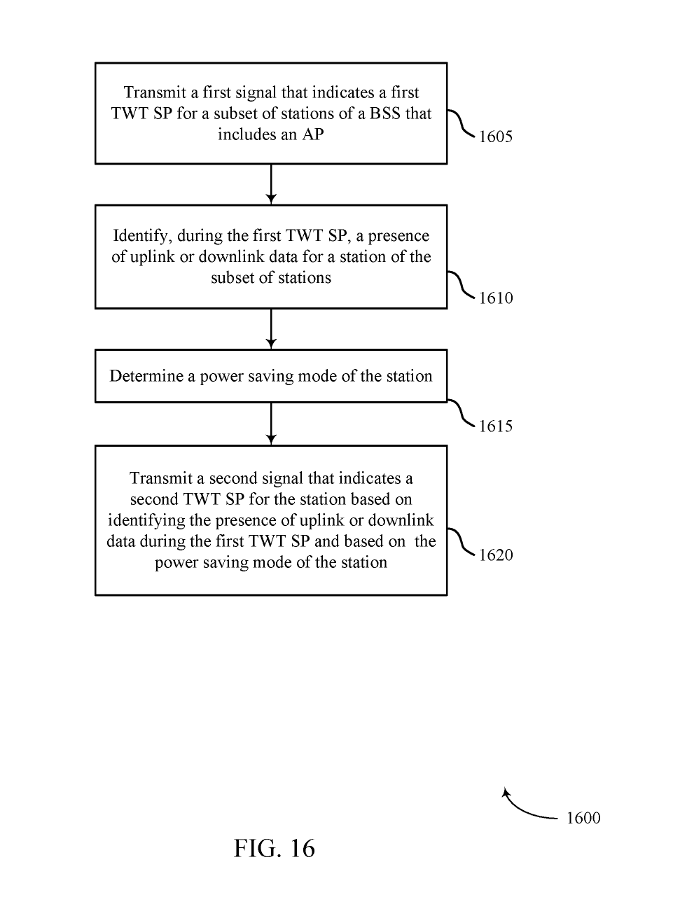

FIG. 16 shows a flowchart illustrating a method 1600 for dynamic broadcast time to wake service period allocation in accordance with various aspects of the present disclosure. The operations of method 1600 may be implemented by a device such as an AP 105 or its components as described with reference to FIGS. 1 and 2. For example, the operations of method 1600 may be performed by the AP TWT SP manager as described herein. In some examples, the AP 105 may execute a set of codes to control the functional elements of the device to perform the functions described below. Additionally or alternatively, the AP 105 may perform aspects the functions described below using special-purpose hardware.

At block 1605, the AP 105 may transmit a first signal that indicates a first TWT SP for a subset of STAs 115 of a BSS that includes the AP 105 as described above with reference to FIGS. 2 through 4. In certain examples, the operations of block 1605 may be performed by the TWT SP component as described with reference to FIG. 6.

At block 1610, the AP 105 may identify, during the first TWT SP, a presence of uplink or downlink data for an STA 115 of the subset of STAs 115 as described above with reference to FIGS. 2 through 4. In certain examples, the operations of block 1610 may be performed by the data identifying component as described with reference to FIG. 6.

At block 1615, the AP 105 may determine a power saving mode of the STA 115, where a second signal is transmitted to the STA 115 based on the determination of the power saving mode of the STA 115 as described above with reference to FIGS. 2 through 4. In certain examples, the operations of block 1615 may be performed by the power saving mode component as described with reference to FIG. 6.

At block 1620, the AP 105 may transmit the second signal that indicates a second TWT SP for the STA 115 based on identifying the presence of uplink or downlink data during the first TWT SP as described above with reference to FIGS. 2 through 4. In certain examples, the operations of block 1620 may be performed by the TWT SP component as described with reference to FIG. 6.

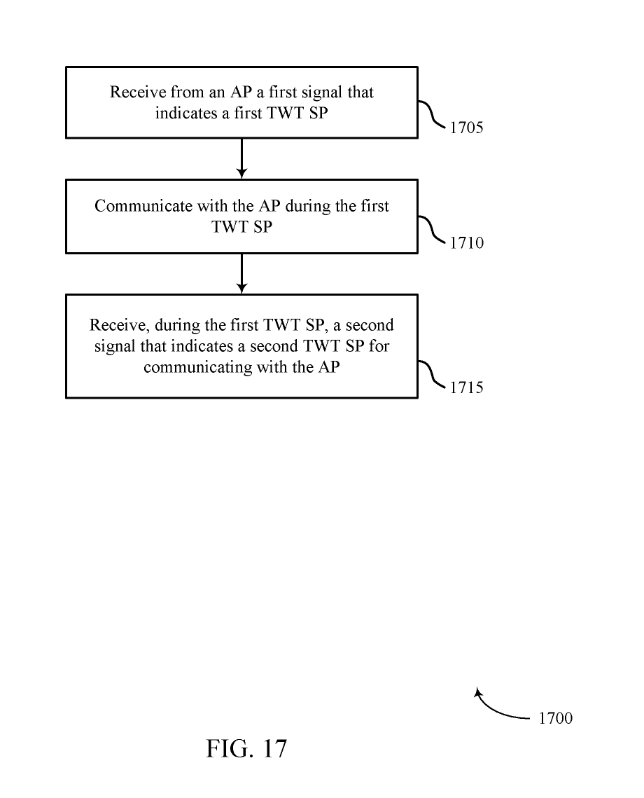

FIG. 17 shows a flowchart illustrating a method 1700 for dynamic broadcast time to wake service period allocation in accordance with various aspects of the present disclosure. The operations of method 1700 may be implemented by a device such as an STA 115 or its components as described with reference to FIGS. 1 and 2. For example, the operations of method 1700 may be performed by the STA TWT SP manager as described herein. In some examples, the STA 115 may execute a set of codes to control the functional elements of the device to perform the functions described below. Additionally or alternatively, the STA 115 may perform aspects the functions described below using special-purpose hardware.

At block 1705, the STA 115 may receive from an AP 105 a first signal that indicates a first TWT SP as described above with reference to FIGS. 2 through 4. In certain examples, the operations of block 1705 may be performed by the TWT SP component as described with reference to FIG. 10.

At block 1710, the STA 115 may communicate with the AP 105 during the first TWT SP as described above with reference to FIGS. 2 through 4. In certain examples, the operations of block 1710 may be performed by the communications component as described with reference to FIG. 10.

At block 1715, the STA 115 may receive, during the first TWT SP, a second signal that indicates a second TWT SP for communicating with the AP 105 as described above with reference to FIGS. 2 through 4. In certain examples, the operations of block 1715 may be performed by the TWT SP component as described with reference to FIG. 10.

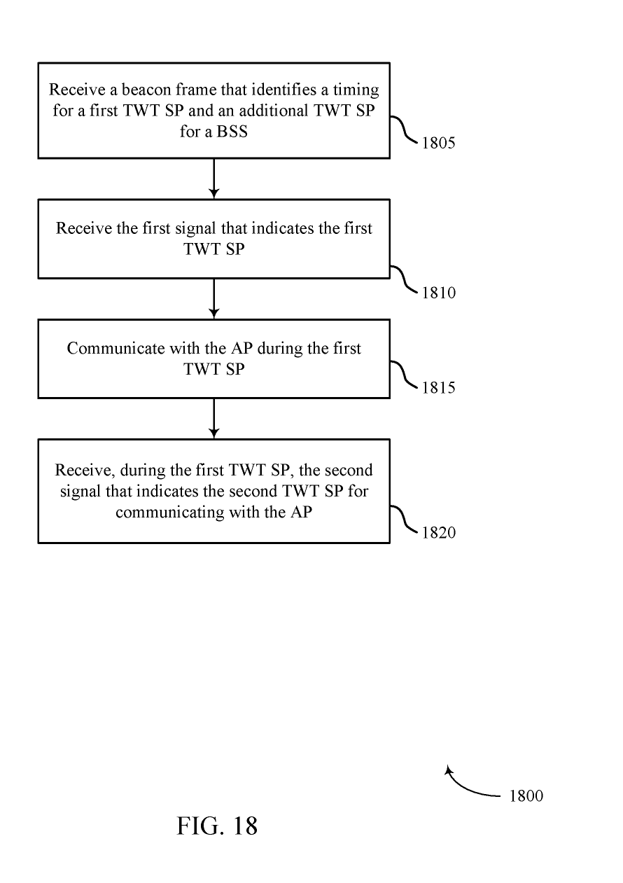

FIG. 18 shows a flowchart illustrating a method 1800 for dynamic broadcast time to wake service period allocation in accordance with various aspects of the present disclosure. The operations of method 1800 may be implemented by a device such as an STA 115 or its components as described with reference to FIGS. 1 and 2. For example, the operations of method 1800 may be performed by the STA TWT SP manager as described herein. In some examples, the STA 115 may execute a set of codes to control the functional elements of the device to perform the functions described below. Additionally or alternatively, the STA 115 may perform aspects the functions described below using special-purpose hardware.

At block 1805, the STA 115 may receive a beacon frame that identifies a timing for a first TWT SP and an additional TWT SP for a BSS, where a first signal includes a trigger frame for a subset of STAs 115 of the BSS as described above with reference to FIGS. 2 through 4. In certain examples, the operations of block 1805 may be performed by the beacon frame component as described with reference to FIG. 10.

At block 1810, the STA 115 may receive from an AP 105 the first signal that indicates the first TWT SP as described above with reference to FIGS. 2 through 4. In certain examples, the operations of block 1810 may be performed by the TWT SP component as described with reference to FIG. 10.

At block 1815, the STA 115 may communicate with the AP 105 during the first TWT SP as described above with reference to FIGS. 2 through 4. In certain examples, the operations of block 1815 may be performed by the communications component as described with reference to FIG. 10.

At block 1820, the STA 115 may receive, during the first TWT SP, a second signal that indicates the second TWT SP for communicating with the AP 105 as described above with reference to FIGS. 2 through 4. In certain examples, the operations of block 1820 may be performed by the TWT SP component as described with reference to FIG. 10.

It should be noted that these methods describe possible implementation, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for dynamic broadcast time to wake service period allocation.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates an inclusive list such that, for example, a phrase referring to “at least one of” a list of items refers to any combination of those items, including single members. As an example, “at least one of: A, B, or C” is intended to cover A, B, C, A-B, A-C, B-C, and A-B-C., as well as any combination with multiples of the same element (e.g., A-A A-A-A, A-A-B, A-A-C, A-B-B, A-C-C, B-B, B-B-B, B-B-C, C-C, and C-C-C or any other ordering of A, B, and C).

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The wireless communications system or systems described herein may support synchronous or asynchronous operation. For synchronous operation, the APs may have similar frame timing, and transmissions from different APs may be approximately aligned in time. For asynchronous operation, the APs may have different frame timing, and transmissions from different APs may not be aligned in time. The techniques described herein may be used for either synchronous or asynchronous operations.

Thus, aspects of the disclosure may provide for dynamic broadcast time to wake service period allocation. It should be noted that these methods describe possible implementations, and that the operations and the steps may be rearranged or otherwise modified such that other implementations are possible. In some examples, aspects from two or more of the methods may be combined.

The various illustrative blocks and modules described in connection with the disclosure herein may be implemented or performed with a general-purpose processor, a DSP, an ASIC, a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

What is claimed is:

1. A method of wireless communication at an access point (AP), comprising:
transmitting a first signal that indicates a first target wake time (TWT) service period (SP) for a subset of stations of a basic service set (BSS) that includes the AP;
identifying, during the first TWT SP, a presence of uplink or downlink data for a station of the subset of stations; and
transmitting a second signal that indicates a second TWT SP for the station based at least in part on identifying the presence of uplink or downlink data during the first TWT SP.

2. The method of claim 1, further comprising:
broadcasting a beacon frame that identifies a timing for the first TWT SP or an additional TWT SP for the BSS, wherein the first signal comprises a trigger frame for the subset of stations.

3. The method of claim 2, wherein a beacon period initiated by the beacon frame comprises the first TWT SP and the second TWT SP.

4. The method of claim 2, wherein a beacon period initiated by the beacon frame comprises the first TWT SP, and wherein a subsequent beacon period comprises the second TWT SP.

5. The method of claim 2, wherein the beacon frame indicates a timing of the first signal.

6. The method of claim 1, further comprising:
receiving a message from the station during the first TWT SP, wherein the presence of uplink data for the station is identified based at least in part on the received message.

7. The method of claim 1, further comprising:
determining a power saving mode of the station, wherein the second signal is transmitted to the station based at least in part on the determination of the power saving mode of the station.

8. The method of claim 1, wherein the first signal comprises a first broadcast message transmitted to the subset of stations and the second signal comprises a second broadcast message transmitted to the station and one or more additional stations of the subset of stations.

9. The method of claim 1, wherein the first signal comprises a broadcast message transmitted to the subset of stations and the second signal comprises a unicast message transmitted to the station.

10. The method of claim 1, further comprising:
transmitting a first downlink message to the station during the first TWT SP; and
transmitting a second downlink message to the station during the second TWT SP, wherein the second downlink message transmission is based at least in part on the identified presence of downlink data during the first TWT SP.

11. The method of claim 1, further comprising:
communicating with another subset of stations of the BSS during a third TWT SP, wherein the other subset of stations excludes stations triggered for the first TWT SP.

12. The method of claim 11, wherein the second TWT SP occurs before the third TWT SP.

13. The method of claim 11, wherein the second TWT SP occurs after the third TWT SP.

14. The method of claim 13, further comprising:
identifying, during the third TWT SP, a presence of uplink or downlink data for a station of the other subset of stations;
transmitting a third signal that indicates the second TWT SP for the station of the other subset of stations; and
communicating with the station of the other subset of stations during the second TWT SP.

15. The method of claim 1, further comprising:
communicating with another subset of stations of the BSS during a third TWT SP, wherein the other subset of stations includes stations triggered for the first TWT SP.

16. The method of claim 1, further comprising:
communicating with the station and another subset of stations of the BSS during the second TWT SP.

17. The method of claim 1, wherein the second TWT SP comprises a next TWT SP following the first TWT SP.

18. The method of claim 1, further comprising:
receiving a message from the station that indicates a buffer status of the station; and
receiving uplink data from the station based at least in part on receiving the buffer status.

19. The method of claim 1, further comprising:
receiving uplink data from the station during an interval between the first TWT SP and the second TWT SP.

20. The method of claim 1, further comprising:
determining an operating mode of the station, wherein the first signal or the second signal is transmitted based at least in part on the determination of the operating mode.

21. The method of claim 1, further comprising:
receiving a message from the station that indicates a requested termination time for the first TWT SP; and
determining to transmit a second message based at least in part on the received message.

22. A method of wireless communication at a station, comprising:
receiving from an access point (AP) a first signal that indicates a first target wake time (TWT) service period (SP);
communicating with the AP during the first TWT SP; and
receiving, during the first TWT SP, a second signal that indicates a second TWT SP for communicating with the AP.

23. The method of claim 22, further comprising:
receiving a beacon frame that identifies a timing for the first TWT SP or an additional TWT SP for a basic service set (BSS), wherein the first signal comprises a trigger frame for a subset of stations of the BSS.

24. The method of claim 23, wherein a beacon period initiated by the beacon frame comprises the first TWT SP and the second TWT SP.

25. The method of claim 23, wherein a beacon period initiated by the beacon frame comprises the first TWT SP, and wherein a subsequent beacon period comprises the second TWT SP.

26. The method of claim 23, wherein the beacon frame indicates a timing of the first signal.

27. The method of claim 22, further comprising:
transmitting a message during the first TWT SP, wherein the message indicates a presence of uplink data.

28. The method of claim 22, further comprising:
transmitting a message to the AP that indicates a power saving mode, wherein the second signal is transmitted based at least in part on the power saving mode of the station.

29. The method of claim 22, wherein the first signal comprises a broadcast message transmitted to a subset of stations and the second signal comprises a unicast message transmitted to the station.

30. The method of claim 22, further comprising:
receiving a first downlink message during the first TWT SP; and
receiving a second downlink message during the second TWT SP, wherein the second downlink message transmission comprises data buffered at the AP during the first TWT SP.

31. The method of claim 22, further comprising:
transmitting a message that indicates a buffer status; and
transmitting uplink data during the first TWT SP or the second TWT SP based at least in part on transmitted the buffer status.

32. The method of claim 22, further comprising:
transmitting uplink data from the station during an interval between the first TWT SP and the second TWT SP.

33. The method of claim 22, further comprising:
transmitting a message to the AP that indicates an operating mode, wherein the first signal or the second signal is transmitted based at least in part on the indication of the operating mode.

34. The method of claim 22, further comprising:
transmitting a message that indicates a requested termination time for the first TWT SP, wherein the second signal is transmitted based at least in part on the message.

35. An apparatus for wireless communication comprising:
means for transmitting a first signal that indicates a first target wake time (TWT) service period (SP) for a subset of stations of a basic service set (BSS) that includes an access point (AP);
means for identifying, during the first TWT SP, a presence of uplink or downlink data for a station of the subset of stations; and
means for transmitting a second signal that indicates a second TWT SP for the station based at least in part on identifying the presence of uplink or downlink data during the first TWT SP.

36. The apparatus of claim 35, further comprising:
means for broadcasting a beacon frame that identifies a timing for the first TWT SP or an additional TWT SP for the BSS, wherein the first signal comprises a trigger frame for the subset of stations.

37. The apparatus of claim 36, wherein a beacon period initiated by the beacon frame comprises the first TWT SP and the second TWT SP.

38. The apparatus of claim 36, wherein a beacon period initiated by the beacon frame comprises the first TWT SP, and wherein a subsequent beacon period comprises the second TWT SP.

39. The apparatus of claim 36, wherein the beacon frame indicates a timing of the first signal.

40. The apparatus of claim 35, further comprising:
means for receiving a message from the station during the first TWT SP, wherein the means for identifying the presence of uplink data for the station is operable based at least in part on receiving the message.

41. The apparatus of claim 35, further comprising:
means for determining a power saving mode of the station, wherein the means for transmitting the second signal is operable based at least in part on a determination of the power saving mode of the station.

42. The apparatus of claim 35, wherein the first signal comprises a first broadcast message transmitted to the subset of stations and the second signal comprises a second broadcast message transmitted to the station and one or more additional stations of the subset of stations.

43. The apparatus of claim 35, wherein the first signal comprises a broadcast message transmitted to the subset of stations and the second signal comprises a unicast message transmitted to the station.

44. The apparatus of claim 35, further comprising:
means for transmitting a first downlink message to the station during the first TWT SP; and
means for transmitting a second downlink message to the station during the second TWT SP, wherein the means for transmitting the second downlink message is operable based at least in part on an identified presence of downlink data during the first TWT SP.

45. An apparatus for wireless communication comprising:
means for receiving from an access point (AP) a first signal that indicates a first target wake time (TWT) service period (SP);
means for communicating with the AP during the first TWT SP; and
means for receiving, during the first TWT SP, a second signal that indicates a second TWT SP for communicating with the AP.

46. The apparatus of claim 45, further comprising:
means for receiving a beacon frame that identifies a timing for the first TWT SP or an additional TWT SP for a basic service set (BSS), wherein the first signal comprises a trigger frame for a subset of stations of the BSS.

47. The apparatus of claim 46, wherein a beacon period initiated by the beacon frame comprises the first TWT SP and the second TWT SP.

48. The apparatus of claim 46, wherein a beacon period initiated by the beacon frame comprises the first TWT SP, and wherein a subsequent beacon period comprises the second TWT SP.

49. The apparatus of claim 46, wherein the beacon frame indicates a timing of the first signal.

50. The apparatus of claim 45, further comprising:
means for transmitting a message during the first TWT SP, wherein the message indicates a presence of uplink data.

51. The apparatus of claim 45, further comprising:
means for transmitting a message to the AP that indicates a power saving mode.

52. An apparatus for wireless communication, in a system comprising a processor, memory in electronic communication with the processor, and instructions stored in the memory and operable, when executed by the processor, to cause the apparatus to:
transmit a first signal that indicates a first target wake time (TWT) service period (SP) for a subset of stations of a basic service set (BSS) that includes an access point (AP);
identify, during the first TWT SP, a presence of uplink or downlink data for a station of the subset of stations; and
transmit a second signal that indicates a second TWT SP for the station based at least in part on identifying the presence of uplink or downlink data during the first TWT SP.

53. The apparatus of claim 52, wherein the instructions are operable to cause the apparatus to:
broadcast a beacon frame that identifies a timing for the first TWT SP or an additional TWT SP for the BSS, wherein the first signal comprises a trigger frame for the subset of stations.

54. The apparatus of claim 53, wherein a beacon period initiated by the beacon frame comprises the first TWT SP and the second TWT SP.

55. The apparatus of claim 53, wherein a beacon period initiated by the beacon frame comprises the first TWT SP, and wherein a subsequent beacon period comprises the second TWT SP.

56. The apparatus of claim 53, wherein the beacon frame indicates a timing of the first signal.

57. The apparatus of claim 52, wherein the instructions are operable to cause the processor to:
receive a message from the station during the first TWT SP; and
identify the presence of uplink data for the station based at least in part on the received message.

58. The apparatus of claim 52, wherein the instructions are operable to cause the apparatus to:
determine a power saving mode of the station; and
transmit the second signal to the station based at least in part on a determination of the power saving mode of the station.

59. The apparatus of claim 52, wherein the first signal comprises a first broadcast message transmitted to the subset of stations and the second signal comprises a second broadcast message transmitted to the station and one or more additional stations of the subset of stations.

60. The apparatus of claim 52, wherein the first signal comprises a broadcast message transmitted to the subset of stations and the second signal comprises a unicast message transmitted to the station.

61. The apparatus of claim 52, wherein the instructions are operable to cause the apparatus to:
transmit a first downlink message to the station during the first TWT SP;
transmit a second downlink message to the station during the second TWT SP; and
transmit the second downlink message based at least in part on an identified presence of downlink data during the first TWT SP.

62. The apparatus of claim 52, wherein the instructions are operable to cause the apparatus to:
communicate with another subset of stations of the BSS during a third TWT SP, wherein the other subset of stations excludes stations triggered for the first TWT SP.

63. The apparatus of claim 62, wherein the second TWT SP occurs before the third TWT SP.

64. The apparatus of claim 62, wherein the second TWT SP occurs after the third TWT SP.

65. The apparatus of claim 64, wherein the instructions are operable to cause the apparatus to:
identify, during the third TWT SP, a presence of uplink or downlink data for a station of the other subset of stations;
transmit a third signal that indicates the second TWT SP for the station of the other subset of stations; and
communicate with the station of the other subset of stations during the second TWT SP.

66. The apparatus of claim 52, wherein the instructions are operable to cause the apparatus to:
communicate with another subset of stations of the BSS during a third TWT SP, wherein the other subset of stations includes stations triggered for the first TWT SP.

67. The apparatus of claim 52, wherein the instructions are operable to cause the apparatus to:
communicate with the station and another subset of stations of the BSS during the second TWT SP.

68. The apparatus of claim 52, wherein the second TWT SP comprises a next TWT SP following the first TWT SP.

69. The apparatus of claim 52, wherein the instructions are operable to cause the apparatus to:
receive a message from the station that indicates a buffer status of the station; and
receive uplink data from the station based at least in part on receiving the buffer status.

70. The apparatus of claim 52, wherein the instructions are operable to cause the apparatus to:
receive uplink data from the station during an interval between the first TWT SP and the second TWT SP.

71. An apparatus for wireless communication, in a system comprising a processor, memory in electronic communication with the processor, and instructions stored in the memory and operable, when executed by the processor, to cause the apparatus to:
receive from an access point (AP) a first signal that indicates a first target wake time (TWT) service period (SP);
communicate with the AP during the first TWT SP; and
receive, during the first TWT SP, a second signal that indicates a second TWT SP for communicating with the AP.

72. The apparatus of claim 71, wherein the instructions are operable to cause the apparatus to:
receive a beacon frame that identifies a timing for the first TWT SP or an additional TWT SP for a basic service set (BSS), wherein the first signal comprises a trigger frame for a subset of stations of the BSS.

73. The apparatus of claim 72, wherein a beacon period initiated by the beacon frame comprises the first TWT SP and the second TWT SP.

74. The apparatus of claim 72, wherein a beacon period initiated by the beacon frame comprises the first TWT SP, and wherein a subsequent beacon period comprises the second TWT SP.

75. The apparatus of claim 72, wherein the beacon frame indicates a timing of the first signal.

76. The apparatus of claim 71, wherein the instructions are operable to cause the apparatus to:
transmit a message during the first TWT SP, wherein the message indicates a presence of uplink data.

77. The apparatus of claim 71, wherein the instructions are operable to cause the apparatus to:
transmit a message to the AP that indicates a power saving mode.

78. The apparatus of claim 71, wherein the first signal comprises a broadcast message transmitted to a subset of stations and the second signal comprises a unicast message transmitted to the station.

79. The apparatus of claim 71, wherein the instructions are operable to cause the apparatus to:
receive a first downlink message during the first TWT SP; and
receive a second downlink message during the second TWT SP, wherein the second downlink message transmission comprises data buffered at the AP during the first TWT SP.

80. The apparatus of claim 71, wherein the instructions are operable to cause the apparatus to:
transmit a message that indicates a buffer status; and
transmit uplink data during the first TWT SP or the second TWT SP based at least in part on transmitted the buffer status.

81. A non-transitory computer-readable medium storing code for wireless communication, the code comprising instructions executable to:
transmit a first signal that indicates a first target wake time (TWT) service period (SP) for a subset of stations of a basic service set (BSS) that includes an access point (AP);
identify, during the first TWT SP, a presence of uplink or downlink data for a station of the subset of stations; and
transmit a second signal that indicates a second TWT SP for the station based at least in part on identifying the presence of uplink or downlink data during the first TWT SP.

82. A non-transitory computer-readable medium storing code for wireless communication, the code comprising instructions executable to:
receive from an access point (AP) a first signal that indicates a first target wake time (TWT) service period (SP);
communicate with the AP during the first TWT SP; and
receive, during the first TWT SP, a second signal that indicates a second TWT SP for communicating with the AP.
